(19) United States
(12) Patent Application Publication
(10) Pub. No.: US 2026/0020946 A1
(43) Pub. Date: Jan. 22, 2026

(54) ORAL CARE DEVICE, OPERATION CONTROL METHOD THEREOF, AND COMPUTER READABLE STORAGE MEDIUM

(71) Applicant: GUANGZHOU STARS PULSE CO.,LTD., GUANGZHOU (CN)

(72) Inventor: SHI CHEN, GUANGZHOU (CN)

(21) Appl. No.: 19/274,889

(22) Filed: Jul. 21, 2025

(30) Foreign Application Priority Data
Jul. 19, 2024 (CN) 202410982237.8

(51) Int. Cl. A61C 17/22; A46B 13/02; A46B 15/00; A61C 17/26; A61C 17/34

(52) U.S. Cl. CPC A61C 17/221; A46B 13/023; A46B 15/0006; A46B 15/0008; A61C 17/26; A61C 17/3481

(57) ABSTRACT

An oral care device, an operation control method thereof, and a computer readable storage medium are provided. The oral care device includes a processor, a driving component and a care element. The operation control method includes step: controlling the driving shaft to have different cleaning parameters in different motion orientations based on the motion orientations of the driving shaft. Each of the motion orientations of the driving shaft includes at least one of an absolute position, a relative position, a motion area, and a motion direction. Each of the cleaning parameters includes at least one of a first parameter representing a cleaning effect, a second parameter representing a cleaning time, a third parameter representing a protection effect, and a fourth parameter representing a cleaning range.

### TECHNICAL FIELD

The present disclosure relates to a technical field of oral care, and in particular to an oral care device, an operation control method thereof, and a computer readable storage medium.

### BACKGROUND

At present, oral care devices (such as electric toothbrushes) generally clean various parts of the oral cavity based on predetermined cleaning modes (such as predetermined cleaning intensity, predetermined cleaning time, etc.), which makes it difficult to take into account different cleaning needs of different parts of the oral cavity. For example, when the cleaning intensity is too strong, fragile oral parts may be damaged, while when the cleaning intensity is weak, a cleaning effect of the oral cavity is not guaranteed.

### SUMMARY

The present disclosure provides an operation control method applied to an oral care device. The oral care device includes a processor, a driving component and a care element. The operation control method includes step: controlling the driving shaft to have different cleaning parameters in different motion orientations based on the motion orientations of the driving shaft. Each of the motion orientations of the driving shaft includes at least one of an absolute position, a relative position, a motion area, and a motion direction. Each of the cleaning parameters includes at least one of a first parameter representing a cleaning effect, a second parameter representing a cleaning time, a third parameter representing a protection effect, and a fourth parameter representing a cleaning range.

By setting different cleaning parameters through the motion orientations of the driving shaft, targeted cleaning is performed on detailed positions or areas of the oral cavity. By providing different cleaning methods for different positions or areas of the oral cavity, different cleaning needs of different users are met and a cleaning effect is guaranteed.

### BRIEF DESCRIPTION OF DRAWINGS

FIG. 1 is a schematic diagram of an oral care device according to one embodiment of the present disclosure.

FIG. 2 is an exploded schematic diagram of the oral care device according to one embodiment of the present disclosure.

FIG. 3 is a partial schematic diagram of the oral care device according to one embodiment of the present disclosure.

FIG. 4 is a schematic diagram of a scenario of an operation control method according to one embodiment of the present disclosure.

FIG. 5 is a flow chart of the operation control method according to one embodiment of the present disclosure.

FIG. 6 is a schematic diagram of another scenario of the operation control method according to one embodiment of the present disclosure.

FIG. 7 is a schematic diagram of another scenario of the operation control method according to one embodiment of the present disclosure.

FIG. 8 is a schematic diagram of another scenario of the operation control method according to one embodiment of the present disclosure.

FIG. 9 is a schematic diagram of another scenario of the operation control method according to one embodiment of the present disclosure.

FIG. 10 is a schematic diagram of another scenario of the operation control method according to one embodiment of the present disclosure.

FIG. 11 is a schematic diagram of another scenario of the operation control method according to one embodiment of the present disclosure.

FIG. 12 is a schematic diagram of another scenario of the operation control method according to one embodiment of the present disclosure.

FIG. 13 is a schematic diagram of another scenario of the operation control method according to one embodiment of the present disclosure.

FIG. 14 is a schematic diagram of another scenario of the operation control method according to one embodiment of the present disclosure.

FIG. 15 is a schematic diagram of another scenario of the operation control method according to one embodiment of the present disclosure.

FIG. 16 is a schematic diagram of another scenario of the operation control method according to one embodiment of the present disclosure.

FIG. 17 is a schematic diagram of another scenario of the operation control method according to one embodiment of the present disclosure.

FIG. 18 is another flow chart of the operation control method according to one embodiment of the present disclosure.

FIG. 19 is another flow chart of the operation control method according to one embodiment of the present disclosure.

FIG. 20 is a circuit diagram of an operation control device according to one embodiment of the present disclosure.

FIG. 21 is a schematic diagram of a non-transitory computer readable storage medium connected to a processor according to one embodiment of the present disclosure.

### DETAILED DESCRIPTION

Examples of various embodiments are shown in the accompanying drawings, and same or similar reference numerals represent the same or similar elements or elements with the same or similar functions throughout the accompanying drawings.

To facilitate understanding of the present disclosure, terms in the present disclosure are explained below:

An oral care device is a device configured to provide care to an oral cavity of a user.

The oral care device of the present disclosure may be one of an electric toothbrush, a dental cleaning instrument, an oral irrigator, an interdental cleaning device, and a dental floss cleaning device. The oral care device of the present disclosure is described by taking the electric toothbrush as an example. Principles of the electric toothbrush and other oral care devices are similar, which are not described in detail one by one.

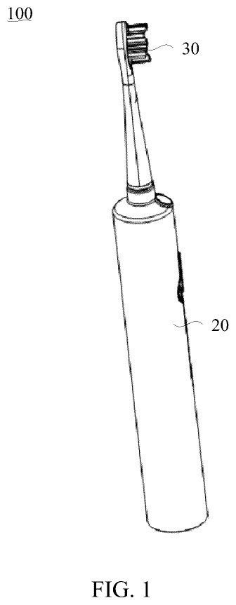

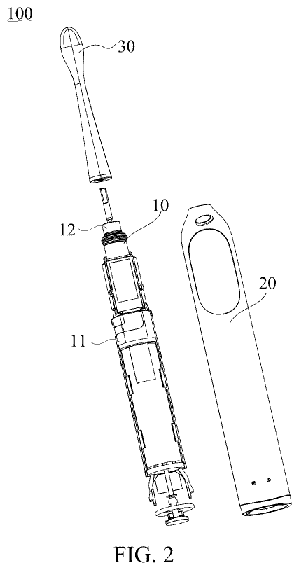

As shown in FIGS. 1-3, the oral care device 100 includes an internal component 10, a handle shell 20, and a care element 30. The internal component 10 includes a mounting bracket 11 and a driving component 12 mounted on the mounting bracket 11. The care element 30, such as a brush head, is configured to care for the oral cavity, such as cleaning teeth. The care element 30 is connected to the driving component 12. The driving component 12 is configured to drive the care element 30 to move.

In some embodiments, the driving component includes a driving motor, and the driving motor may be a servo motor. The servo motor has at least one of an axial rotation freedom and a circumferential rotation freedom. The driving component 12 includes a driving shaft 121 and a stator module 122. The stator module 122 is disposed on a circumference of the driving shaft 121. The driving shaft 121 is connected to the stator module 122, and the driving shaft 121 is able to rotate and/or retract relative to the stator module 122. One end of the driving shaft 121 stretches out of the handle shell 20 and is connected to the care element 30. The driving shaft 121 is configured to drive the care element 30 to rotate and/or retract.

For ease of understanding, the following description is made by taking the rotation of the driving shaft 121 relative to the stator module 122 as an example. A principle how the driving shaft 121 is stretched relative to the stator module 122 is similar to a principle how the driving shaft 121 is simultaneously rotated and stretched relative to the stator module 122, which is not repeatedly described.

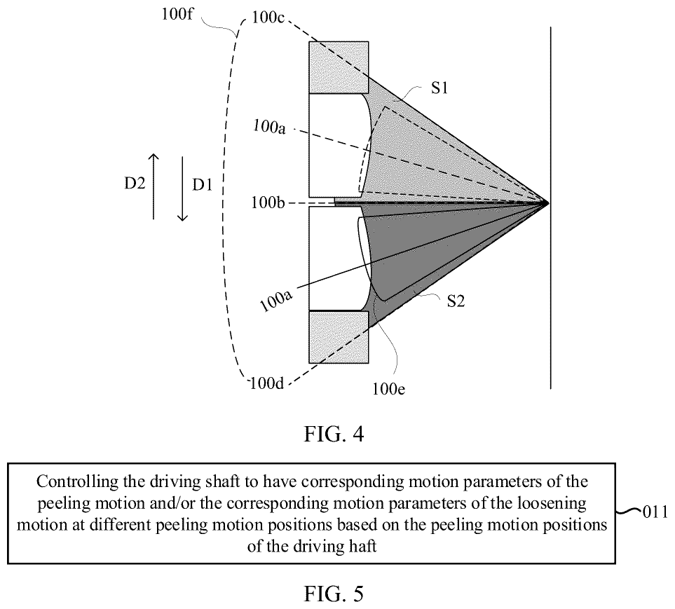

Optionally, as shown in FIG. 4, the driving shaft 121 reciprocates around a rotor shaft 1211 of the driving shaft 121 with a reference position 100a as a center, and the driving shaft 121 rotates circumferentially to switch the reference position 100a. That is, the rotor shaft 1211 has at least two functions when rotating. For ease of description, a rotation motion of the rotor shaft 1211 is divided into a peeling motion and a loosening motion. The peeling motion is mainly configured to adjust the reference position of the rotor shaft 1211, and the loosening motion is mainly a reciprocating motion configured to clean the teeth.

Optionally, the peeling motion is a sweeping motion, and the loosening motion is a vibration motion.

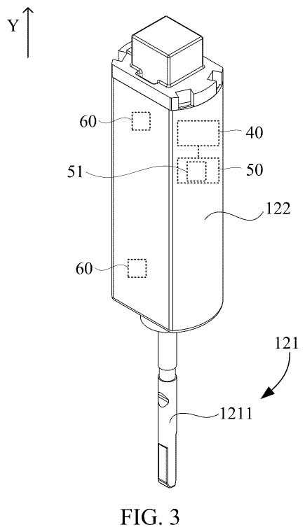

Optionally, the loosening motion and the peeling motion are performed by the driving motor. For example, as shown in FIG. 3, the loosening motion and the peeling motion are performed by the servo motor. In other embodiments, the peeling motion and the loosening motion are respectively performed by one motor, and the driving shaft 121 outputs a superimposed motion of the peeling motion and the loosening motion.

In some embodiments, the loosening motion and the peeling motion include at least one of rotation and translation, and the rotor shaft and a translation direction of the driving shaft are parallel to a long axis of the oral care device. As shown in FIG. 3, the rotor shaft 1211 and the translation direction of the driving shaft 121 are parallel to the long axis Y of the oral care device.

As shown in FIG. 4, a motion range of the driving shaft 121 during the loosening motion is defined as a first motion range 100e, and the loosening motion includes a first reciprocating motion of the driving shaft 121 within the first motion range. The first motion range 100e corresponds to a cleaning area of the care element 30, and the first motion range 100e is adjustable. It is understood that the first motion range 100e of the driving shaft 121 has a suitable size. If first motion range 100e is too large or too small, it is not conducive to cleaning operation of the oral care device 100.

When the driving shaft performs the peeling motion, the reference position performs a second reciprocating motion within a second motion range.

The second motion range 100f includes a reference axis 100b, a first limit position 100c, and a second limit position 100d. An area between the first limit position 100c and the second limit position 100d is defined as the second motion range 100f.

The first motion range 100e is less than the second motion range 100f, and a frequency of the first reciprocating motion is greater than a frequency of the second reciprocating motion. That is, the loosening motion is a high-frequency small-range motion, and the peeling motion is a low-frequency large-range motion.

When the first motion range 100e of the driving shaft 121 is of a certain size, a position of the driving shaft 121 relative to the teeth is changed by sweeping the driving shaft 121 within the second motion range 100f, so as to change the position of the first motion range 100e relative to the teeth. Then, the oral care device 100 controls the driving shaft 121 to perform the loosening motion within the first motion range 100e after the driving shaft is switched to the first motion range, so that the first motion range 100e covers more areas to be cleaned. In this way, by superimposing the loosening motion on the peeling motion, it ensures that the care element 30 performs the loosening motion at a higher frequency (relative to the peeling motion) within the smaller first motion range 100e, so that the care element 30 smoothly loosens plaque on the teeth. Moreover, by changing or switching a center position of the loosening motion, while ensuring a cleaning effect of the care element 30, a cleaning range of the oral care device 100 is expanded.

In some embodiments, the loosening motion and the peeling motion are coaxial. For example, the loosening motion and the peeling motion are reciprocating rotation motions with an axis of the driving shaft 121 as the axis. A rotation angle of the loosening motion is less than a rotation angle of the peeling motion, and a trajectory of the peeling motion is formed by a position switching of the motion center of the loosening motion.

In other embodiments, the loosening motion and the peeling motion may be linear reciprocating motions along the driving shaft 121. A reciprocating length of the loosening motion is less than a reciprocating length of the peeling motion, and a trajectory of the peeling motion is formed by the position switching of the motion center of the loosening motion.

In some other embodiments, the loosening motion and the peeling motion are non-coaxial, one of which is a linear reciprocating motion and the other is a reciprocating rotation motion, which are realized by superimposing motions of two motors.

The plaque on the tooth surfaces is loosened by high-frequency and small-range notion in one direction, and then the position of the loosening motion is switched by superimposing a low-frequency and large-range motion in another direction, so that loosened plaque is scraped off the tooth surfaces to achieve plaque peeling. It should be noted that the terms “high frequency”, “low frequency”, “large-range”, and “small-range” mentioned in the specification are relatively terms depicting a comparing result of the loosening motion and the peeling motion.

For example, a frequency of the loosening motion is 100-1000 Hz, and a frequency of the peeling motion is 3-30 Hz. The first motion range of the loosening motion is ±0.5°˜±3°, and the second motion range of the peeling motion is ±10°˜±45°, or, the first motion range of the loosening motion is ±0.5 mm˜±2 mm, and the second motion range of the peeling motion is ±4 mm˜±15 mm.

In summary, the driving motor 12 of the embodiment of the present disclosure performs the loosening motion while realizing the position switching, the care element covers a wide tooth surface by enabling the rotor shaft 1211 to switch the reference position 100a while loosening the plaque, thereby increasing the cleaning effect of the tooth surface. When a holding posture of the user remains unchanged, the care element 30 is deflected to expand the cleaning range and improve the cleaning effect.

In some embodiments, before the drive motor 12 is about to rotate, the driving shaft 121 is reset by rotating to the reference axis 100b. The oral care device 100 defines a front side and a rear side disposed opposite to the front side. Generally speaking, when the rotor shaft 1211 is located at the reference axis 100b, the care element 30 is located in a center of the front side, so as to meet the expectations of most users for a position of the care element 30 and facilitate user use. Therefore, when the user brushes the teeth, the user would not hold the oral care device at a wrong angle and a wrong posture due to the deflection of the care element 30, thereby ensuring a brushing effect. It should be noted that the driving shaft 121 is able to reset directly, or the driving shaft 121 is able to detect its own position first and then reset according to its own position.

In some embodiments, the driving shaft 121 performs a switching motion in the second motion range 100f to deflect the reference position 100a, and the reference position 100a performs a continuous second reciprocating motion in the second motion range 100f by the deflection of the driving shaft 121. As shown in FIG. 4, by controlling the driving shaft 121 to switch the reference position 100a in the second motion range 100f, the driving shaft 121 performs the loosening motion in the first motion range 100e while the reference position 100a is switched.

As shown in FIG. 3, in some embodiments, the driving component includes at least one position detector 60. The at least one position detector 60 is configured to detect a motion position and/or a motion direction of the driving shaft 121, and a current motion orientation of the driving shaft 121 is determined based on the motion position and/or the motion direction of the driving shaft 121.

The at least one position detector 60 is a position sensor (such as a Hall sensor, etc.) configured to detect the motion direction (such as an upward motion of the driving shaft, etc.) and/or the motion position (such as the position of the driving shaft, etc.) of the driving shaft, and determine the current motion orientation of the driving shaft according to the motion direction and/or the motion position of the driving shaft.

Based on the introduction of the above-mentioned related scenarios, the embodiment of the present disclosure provides an operation control method of an oral care device. The operation control method of the oral care device is introduced in detail below in combination with schematic diagrams of the oral care device, flow charts of the operation control method, and schematic diagrams of scenarios of the operation control method. The oral care device in the operation control method may refer to the oral care device 100, which is not repeatedly described herein. In some scenarios of the operation control method of the oral care device, FIGS. 4, 6, and 7 are taken as examples. 100b in FIGS. 4, 6, and 7 represents the reference axis, 100c represents the first limit position, and 100d represents the second limit position.

As shown in FIG. 5, the operation control method of the oral care device includes step 011. The step 011 includes controlling the driving shaft to have different cleaning parameters in different motion orientations based on the motion orientations of the driving shaft.

Each of the motion orientations of the driving shaft includes at least one of the position of the driving shaft and the motion direction of the driving shaft.

Optionally, each of the motion orientations of the driving shaft includes at least one of an absolute position, a relative position, a motion area, and a motion direction. That is, each of the motion orientations of the driving shaft includes one of the absolute position, the relative position, the motion area, and the motion direction. Alternatively, each of the motion orientations of the driving shaft includes two of the absolute position, the relative position, the motion area, and the motion direction. Alternatively, each of the motion orientations of the driving shaft includes three of the absolute position, the relative position, the motion area, and the motion direction. Alternatively, each of the motion orientations of the driving shaft includes all of the absolute position, the relative position, the motion area, and the motion direction.

In some embodiments, the driving shaft moves between the first limit position and the second limit position, and the first limit position and the second limit position are located on two sides of the reference axis.

The absolute position includes a position between the first limit position and the second limit position.

For example, as shown in FIG. 4, the current motion orientation of the driving shaft may include the position between the first limit position 100c and the second limit position 100d.

The relative position is a position relative to the reference axis, the first limit position, or the second limit position.

For example, as shown in FIG. 4, the current motion orientation of the driving shaft may include one of the position relative to the reference axis, the first limit position, and the second limit position.

The motion area includes an area between the first limit position and the second limit position.

For example, as shown in FIG. 4, the current motion orientation of the driving shaft is an area S1 between the reference axis 100b and the first limit position 100c and an area S2 between the reference axis 100b and the second limit position 100d.

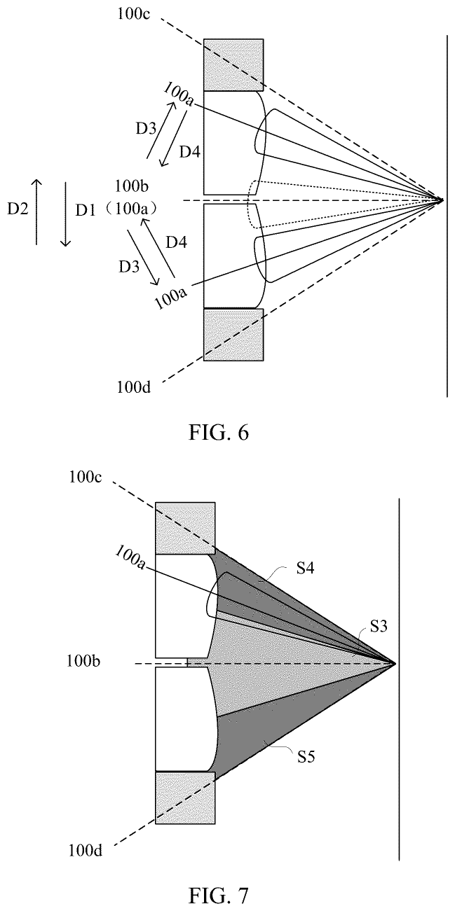

For another example, as shown in FIG. 7, the current motion orientation of the driving shaft is a middle area S3 and a first edge area S4 and a second edge area S5. The first edge area and the second edge area are respectively located on two sides of the middle area S3.

The motion direction is a current motion direction of the driving shaft.

Optionally, the motion direction includes an absolute direction and a relative direction.

The absolute direction includes a direction from the first limit position to the second limit position and a direction from the second limit position to the first limit position.

For example, as shown in FIG. 4, the motion direction includes the direction D1 from the first limit position 100c to the second limit position 100d and the direction D2 from the second limit position 100d to the first limit position 100c.

The relative direction includes a direction away from the reference axis and a direction close to the reference axis.

For example, as shown in FIG. 6, the motion direction includes the direction D3 away from the reference axis 100b and a direction D4 close to the reference axis 100b.

Optionally, each of the cleaning parameters includes at least one of a first parameter representing a cleaning effect, a second parameter representing a cleaning time, a third parameter representing a protection effect, and a fourth parameter representing a cleaning range. That is, each of the cleaning parameters include at least one of the first parameter, the second parameter, the third parameter, and the fourth parameter.

The cleaning effect is the cleaning effect of the teeth (e.g., an amount of the plaque being removed, etc.). The cleaning time is a time for cleaning the teeth, such as 20 seconds(s), 30 s, 40 s, etc. The protection effect includes a protection effect on the gums, the tooth surfaces, etc. The cleaning range is the cleaning range on the tooth surfaces when the care element cleans the teeth. By setting the cleaning range, an actual motion range within the first motion range is changed when the oral care device performs the loosening motion.

Optionally, the first parameter includes at least one of a cleaning frequency, a cleaning intensity, a cleaning amplitude, and a motion speed. The second parameter includes at least one of the motion speed, a position switching speed, and a position switching amplitude. The third parameter includes at least one of the motion speed, the position switching speed, the position switching amplitude, the cleaning frequency, the cleaning intensity, and the cleaning amplitude. The fourth parameter includes the cleaning range.

The cleaning frequency is the number of reciprocating motions completed by the oral care device in a unit time (such as 1s, 2s, 3s, etc.) when the oral care device cleans the teeth through the reciprocating motion. The cleaning intensity is a vibration intensity of the reciprocating motion of the oral care device when cleaning the teeth. The cleaning amplitude is the range between the first limit position and the second limit position of the reciprocating motion when the oral care device cleans the teeth through the reciprocating motion. The motion speed is a rotation angle or a motion distance per unit time when the oral care device cleans the teeth through the reciprocating motion. The reciprocating motion is the vibration motion.

The position switching amplitude is a deflect angle or a deflect distance of each deflection of the reference axis. The position switching speed is a speed at which the reference axis deflects per unit time. That is, the position switching speed is a ratio of the position switching amplitude to the unit time.

Loosening motion parameters include at least one of the cleaning frequency, the cleaning intensity, and the cleaning amplitude. The peeling motion parameters include at least one of the motion speed, the position switching speed, and the position switching amplitude.

Optionally, the cleaning effect corresponding to the first parameter is positively correlated with at least one of the cleaning frequency, the cleaning intensity, and the cleaning amplitude of the loosening motion, and/or the cleaning effect corresponding to the first parameter is negatively correlated with the motion speed of the peeling motion.

The cleaning time corresponding to the second parameter is negatively correlated with at least one of the motion speed, the position switching speed, and the position switching amplitude of the peeling motion.

The protection effect corresponding to the third parameter is negatively correlated with at least one of the cleaning frequency, the cleaning intensity, and the cleaning amplitude of the loosening motion, and/or the protection effect corresponding to the third parameter is negatively correlated with at least one of the motion speed, the position switching speed, and the position switching amplitude of the peeling motion.

The cleaning effect corresponding to the first parameter is positively correlated with at least one of the cleaning frequency, the cleaning intensity, and the cleaning amplitude of the loosening motion. For example, the cleaning effect corresponding to the first parameter is positively correlated with the cleaning frequency of the loosening motion, or, the cleaning effect corresponding to the first parameter is positively correlated with the cleaning frequency, the cleaning intensity, and the cleaning amplitude of the loosening motion, etc., which is not limited thereto and is not listed here one by one. For another example, taking an example that the cleaning effect corresponding to the first parameter is positively correlated with the cleaning frequency of the loosening motion, the greater the cleaning frequency of the loosening motion, the better the cleaning effect corresponding to the first parameter.

Specifically, the cleaning effect corresponding to the first parameter is negatively correlated with the motion speed of the peeling motion. That is, the slower the motion speed of the peeling motion, the better the cleaning effect corresponding to the first parameter.

Specifically, the cleaning time corresponding to the second parameter is negatively correlated with at least one of the motion speed, the position switching speed and the position switching amplitude of the peeling motion. The smaller at least one of the motion speed, the position switching speed, and the position switching amplitude of the peeling motion is, the longer the cleaning time corresponding to the second parameter is.

Specifically, the protection effect corresponding to the third parameter is negatively correlated with at least one of the cleaning frequency, the cleaning intensity, and the cleaning amplitude of the loosening motion. For example, taking the cleaning frequency of the loosening motion as an example, the greater the cleaning frequency of the loosening motion, the greater an impact of the oral care device on the teeth. Therefore, the smaller at least one of the cleaning frequency, the cleaning intensity, and the cleaning amplitude of the loosening motion, the better the protection effect corresponding to the third parameter.

Optionally, peeling motion parameters include the position switching speed and the position switching amplitude. The first motion range is located in the second motion range. The reference axis of the first motion range changes within the second motion range. The position switching speed of the peeling motion is the switching speed of the reference axis of the first motion range. The position switching amplitude of the peeling motion is the switching amplitude of the reference axis of the first motion range.

For example, as shown in FIG. 4, the first motion range 100e is located in the second motion range 100f. The reference axis 100b of the first motion range 100e changes within the second motion range 100f. The position switching speed of the peeling motion is the switching speed of the reference axis 100b of the first motion range 100e. The position switching amplitude of the peeling motion is the switching amplitude of the reference axis 100b of the first motion range 100e.

Optionally, the motion speed of the peeling motion corresponding to the current motion orientation of the driving shaft is negatively correlated with the cleaning amplitude of the loosening motion, and/or the motion speed of the peeling motion corresponding to the current motion orientation of the driving shaft is positively correlated with the cleaning frequency of the loosening motion.

Specifically, the greater the motion speed of the peeling motion (the faster the care element sweeps across the tooth surfaces), the smaller the cleaning amplitude of the loosening motion. The motion speed of the peeling motion corresponding to the current motion orientation of the driving shaft is negatively correlated with the cleaning amplitude of the loosening motion, which avoids the oral care device with strong swing and strong amplitude from damaging the teeth.

Generally speaking, when approaching a fragile and sensitive area of the teeth, the motion speed of the peeling motion and the cleaning frequency of the loosening motion decrease to avoid damaging the fragile and sensitive area of the teeth. Therefore, the motion speed of the peeling motion corresponding to the current motion orientation of the driving shaft is positively correlated with the cleaning frequency of the loosening motion.

Optionally, in different motion periods, the cleaning parameters corresponding to motion positions of the driving shafts are the same or different.

During care, the driving shaft performs the reciprocating motion in the motion periods. Each of the motion periods is defined as a duration of the driving shaft performing the first reciprocating motion and/or the second reciprocating motion. In different motion periods, when the driving shaft passes through a same motion position, corresponding cleaning parameters are the same or different.

Specifically, when the oral care device cleans in different directions, the oral parts passed successively are different. For example, when the driving shaft moves from the first limit position to the second limit position, the oral care device generally passes through tooth tips first and then tooth roots. Therefore, when the motion direction of the current motion orientation is from the first limit position to the second limit position, since the tooth roots are more dirty than the tooth tips, the cleaning effect corresponding to the first parameter and the cleaning time corresponding to the second parameter should be gradually increased. Further, since the tooth roots are more fragile than the tooth tips, the protection effect corresponding to the third parameter is gradually increased. When the driving shaft moves from the second limit position to the first limit position, the oral care device generally passes through the tooth roots first and then the tooth tips. Therefore, when the motion direction of the current motion orientation of the driving shaft is from the second limit position to the first limit position, the cleaning effect corresponding to the first parameter and the cleaning time corresponding to the second parameter should gradually decrease, and the protection effect corresponding to the third parameter gradually decreases.

For example, taking the current motion orientation including the motion direction as an example, when the motion direction is from the first limit position to the second limit position, and when the first parameter includes the cleaning frequency and the cleaning intensity, the increase in the cleaning effect corresponding to the first parameter may be an increase in at least one of the cleaning frequency and the cleaning intensity. Since the cleaning effect corresponding to the first parameter is positively correlated with at least one of the cleaning frequency, the cleaning intensity and the cleaning amplitude of the loosening motion, and/or the cleaning effect corresponding to the first parameter is negatively correlated with the motion speed of the peeling motion, the increase in the cleaning effect corresponding to the first parameter may be an increase in at least one of the cleaning frequency, the cleaning intensity, and the cleaning amplitude of the loosening motion (e.g., the cleaning frequency and the cleaning intensity of the loosening motion increase, etc.), and/or a decrease in the motion speed of the peeling motion.

When the motion direction is from the first limit position to the second limit position, taking the second parameter including the motion speed and the position switching speed as an example, the increase in the cleaning time corresponding to the second parameter may be a decrease in the motion speed and the position switching speed, etc., so as to increase the cleaning time corresponding to the second parameter. The cleaning time corresponding to the second parameter is negatively correlated with at least one of the motion speed, the position switching speed and the position switching amplitude of the peeling motion. Therefore, the increase in the cleaning time corresponding to the second parameter of the driving shaft may be a decrease in at least one of the motion speed, the position switching speed, and the position switching amplitude of the peeling motion of the oral care device (e.g., the position switching speed and position switching amplitude of the peeling motion decreases, etc.).

When the motion direction is from the first limit position to the second limit position, taking the third parameter including the motion speed and the cleaning intensity as an example, the increase in the protection effect corresponding to the third parameter is to reduce the motion speed and the cleaning intensity to increase the protection effect corresponding to the third parameter. The protection effect corresponding to the third parameter is negatively correlated with at least one of the cleaning frequency, the cleaning intensity, and the cleaning amplitude of the loosening motion, and/or the protection effect corresponding to the third parameter is negatively correlated with at least one of the motion speed, the position switching speed, and the position switching amplitude of the peeling motion. Therefore, the increase in the protection effect corresponding to the third parameter is to decrease at least one of the cleaning frequency, the cleaning intensity, and the cleaning amplitude of the loosening motion (for example, decrease the cleaning frequency and the cleaning intensity of the loosening motion, etc.), and/or decrease at least one of the motion speed, the position switching speed, and the position switching amplitude of the peeling motion (e.g., decrease the motion speed, the position switching speed, and the position switching amplitude of the peeling motion, etc.).

For another example, when the motion direction is from the second limit position to the first limit position, taking the first parameter including the cleaning frequency, the cleaning intensity, the cleaning amplitude, and the motion speed as an example, a decrease in the cleaning effect corresponding to the first parameter may be a decrease in at least one of the cleaning frequency, the cleaning intensity, the cleaning amplitude, and the motion speed (such as the cleaning frequency and the motion speed, etc.). The decrease in the cleaning effect corresponding to the first parameter maybe a decrease in at least one of the cleaning frequency, the cleaning intensity, and the cleaning amplitude of the loosening motion (e.g., the cleaning frequency and the cleaning intensity of the loosening motion, etc.), and/or an increase in the motion speed of the peeling motion.

When the motion direction is from the second limit position to the first limit position, taking the second parameter including the motion speed as an example, the decrease in the cleaning time corresponding to the second parameter is to increase the motion speed, so as to reduce the cleaning time corresponding to the second parameter. Alternatively, at least one of the motion speed, the position switching speed, and the position switching amplitude of the peeling motion increases (e.g., the position switching speed and position switching amplitude of the peeling motion are increased, etc.) to achieve the decrease in the cleaning time corresponding to the second parameter.

When the motion direction is from the second limit position to the first limit position, taking the third parameter including the motion speed as an example, the decrease in the protection effect corresponding to the third parameter is to increase the motion speed, so as to decrease the protection effect corresponding to the third parameter. Alternatively, at least one of the cleaning frequency, the cleaning intensity, and cleaning amplitude of the loosening motion (e.g., the cleaning frequency, the cleaning intensity, and the cleaning amplitude of the loosening motion are increased) is increased to achieve the decrease in the protection effect corresponding to the third parameter, and/or at least one of the motion speed, the position switching speed, and the position switching amplitude of the peeling motion increased (e.g., the motion speed and the position switching speed of the peeling motion, etc., are increased) to achieve the decrease in the protection effect corresponding to the third parameter.

In this way, different cleaning parameters are set according to the motion orientations of the driving shaft, and targeted cleaning is performed on detailed positions or areas of the oral cavity. By providing diverse cleaning methods for different positions or areas of the oral cavity, more cleaning needs are met and the cleaning effect is guaranteed.

When the user performs oral care, at least one of the following scenarios is included:

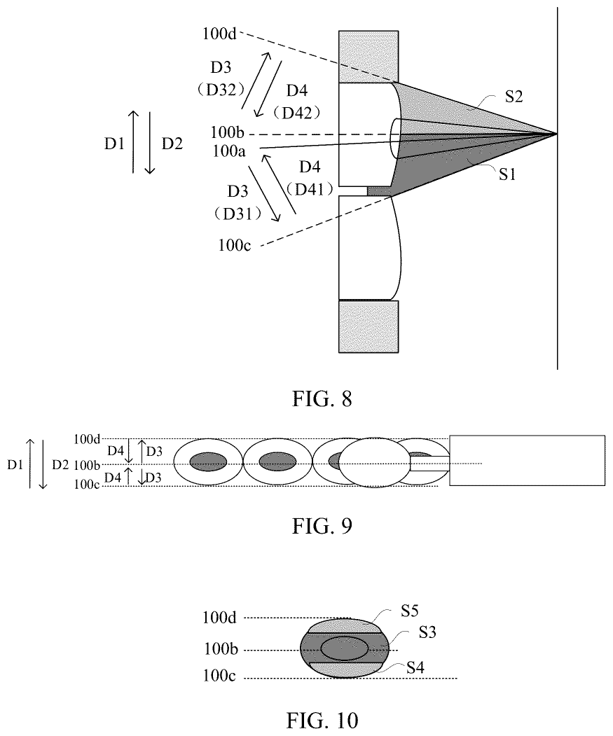

Scenario (1): As shown in FIG. 8, when the user brushes the teeth, the reference axis 100b of the peeling motion is generally aligned with a middle position of a single tooth (first tooth), the first limit position 100c of the peeling motion is a tooth tip of another tooth (second tooth), and the second limit position 100d is a tooth root of the first tooth.

Scenario (2): Referring to FIG. 4, when the user brushes the teeth, the reference axis 100b of the peeling motion is generally aligned with a middle position of a upper tooth and a lower tooth, the first limit position 100c of the peeling motion is a tooth root of the upper tooth (upper tooth root), and the second limit position 100d is a tooth root of the lower tooth (lower tooth root).

Scenario (3): As shown in FIG. 9, when the user brushes the teeth, the reference axis 100b of the peeling motion is generally aligned with the middle positions of pits and fissures, the first limit position 100c of the peeling motion is a first edge of the pits and fissures, and the second limit position 100d is a second edge of the pits and fissures opposite to the first edge.

In a case where the current motion orientation of the driving shaft includes the absolute position, for the scenario (1), as shown in FIG. 8, the amount of the plaque generated on the tooth tips and the tooth roots is different. That is, the dirtiness degrees of the tooth tips and the tooth roots are different. Generally speaking, the tooth tips are less dirty than the tooth roots, and the tooth roots require a better cleaning effect. Therefore, the closer the current motion orientation is to the first limit position 100c, the weaker the cleaning effect corresponding to the first parameter of the driving shaft, the closer the current motion orientation is to the second limit position 100d, the stronger the cleaning effect corresponding to the first parameter of the driving shaft, so as to improve the cleaning effect of the teeth and meet the cleaning needs of the teeth.

For the scenario (2), as shown in FIG. 4, when the current motion orientation of the driving shaft moves from the first limit position 100c to the second limit position 100d or moves from the second limit position 100d to the first limit position 100c, the driving shaft first approaches the tooth tips and then approaches the tooth roots. Therefore, the cleaning effect corresponding to the first parameter of the driving shaft first decreases and then increases. That is, when the driving shaft is in a process of approaching the tooth roots, the cleaning effect increases, and when the driving shaft is in the process of moving away from the tooth roots, the cleaning effect decreases, thereby improving the cleaning effect of the teeth and meeting the cleaning needs of the teeth and improving the cleaning efficiency.

For the scenario (3), as shown in FIG. 9, the amount of the plaque generated on centers and edges of the pits and fissures is different. That is, the dirtiness degrees of the centers and the edges of the pits and fissures are different. Generally speaking, the edges of the pits and fissures are less dirty than the centers of the pits and fissures. Therefore, when the driving shaft moves from the first limit position 100c to the second limit position 100d or moves from the second limit position 100d to the first limit position 100c, the cleaning effect corresponding to the first parameter of the driving shaft first increases and then decreases. That is, the closer to the centers of the pits and fissures where the dirtiness degree is relatively heavy, the better the cleaning effect, so as to improve the cleaning efficiency while improving the cleaning effect on the teeth and meeting the cleaning needs of the teeth.

In the case where the current motion orientation of the driving shaft includes the absolute position, for the scenario (1), as shown in FIG. 8, generally speaking, the tooth tips are less dirty than the tooth roots, and the tooth roots require a longer cleaning time to ensure a better cleaning effect. Therefore, the closer the current motion orientation is to the first limit position 100c, the shorter the cleaning time corresponding to the second parameter of the driving shaft, the closer the current motion orientation is to the second limit position 100d, the longer the cleaning time corresponding to the second parameter of the driving shaft.

In this way, the closer the motion direction is to the tooth tips, the shorter the cleaning time, and the closer the motion direction is to the tooth roots, the longer the cleaning time, which improves the cleaning efficiency while ensuring the cleaning effect.

For the scenario (2), as shown in FIG. 4, when the current motion orientation of the driving shaft moves from the first limit position 100c to the second limit position 100d or moves from the second limit position 100d to the first limit position 100c, the cleaning time corresponding to the second parameter of the driving shaft first decreases and then increases. That is, the closer the driving shaft is to the tooth roots, the longer the cleaning time, which improves the cleaning efficiency while ensuring the cleaning effect.

For the scenario (3), as shown in FIG. 9, when the driving shaft moves from the first limit position 100c to the second limit position 100d or moves from the second limit position 100d to the first limit position 100c, the cleaning time corresponding to the second parameter of the driving shaft first increases and then decreases. That is, when approaching the centers of the pits and fissures where the dirtiness degree is relatively heavy and more difficult to clean, the cleaning time of the driving shaft increases, and when moving away from the centers of the pits and fissures where the dirtiness degree is relatively heavy and more difficult to clean, the cleaning time decreases, so as to improve the cleaning efficiency while improving the cleaning effect on the teeth and meeting the cleaning needs of the teeth.

In the case where the current motion orientation of the driving shaft includes the absolute position, for the scenario (1), as shown in FIG. 8, compared with the tooth tips, the gum tissue at the tooth roots is softer and more sensitive, and requires more effective protection. The closer the current motion orientation of the driving shaft is to the first limit position 100c, the weaker the protection effect corresponding to the third parameter of the driving shaft. The closer the current motion orientation of the driving shaft is to the second limit position 100d, the stronger the protection effect corresponding to the third parameter of the driving shaft.

For the scenario (2), as shown in FIG. 4, when the current motion orientation of the driving shaft moves from the first limit position 100c to the second limit position 100d or moves from the second limit position 100d to the first limit position 100c, the protection effect corresponding to the third parameter of the driving shaft first decreases and then increases.

Thus, in the scenarios (1) and (2), the closer the current motion orientation of the driving shaft is to the tooth roots where the gum tissue is softer and more sensitive, the stronger the protection effect corresponding to the oral care device, so as to provide targeted protection for different areas of the teeth when cleaning the oral cavity, thereby improving the user experience.

For the scenario (3), as shown in FIG. 9, since the hardness of the centers and edges of the pits and fissures is different, the impact (force) that is withstood by the centers and edges of the pits and fissures is different. In order to provide effective protection for the teeth, when the current motion orientation of the driving shaft moves from the first limit position 100c to the second limit position 100d or moves from the second limit position 100d to the first limit position 100c, the protection effect corresponding to the third parameter of the driving shaft first increases and then decreases. The closer the current motion orientation of the driving shaft to the centers of the pits and fissures, the better the protection effect, which provides effective protection for the teeth and improves the user experience.

In a case where the current motion orientation of the driving shaft includes the relative position, for the scenario (2), as shown in FIG. 4, the closer the current motion orientation is to the reference axis 100b (i.e., away from the tooth roots with a relatively heavy dirtiness degree), the weaker the cleaning effect corresponding to the first parameter of the driving shaft, so as to improve the cleaning effect of the teeth and meet the cleaning needs of the teeth.

For the scenario (3), as shown in FIG. 9, the closer the current motion orientation is to the reference axis 100b (i.e., the closer to the centers of the pits and fissures with a relatively heavy dirtiness degree), the stronger the cleaning effect corresponding to the first parameter of the driving shaft, so as to improve the cleaning effect of the teeth and meet the cleaning needs of the teeth.

In the case where the motion orientation of the driving shaft includes the relative position, for the scenario (2), as shown in FIG. 4, the closer the current motion orientation is to the reference axis 100b (i.e., the closer to the tooth tips of the teeth), the shorter the cleaning time corresponding to the second parameter of the driving shaft, so as to improve the cleaning efficiency while meeting the cleaning effect of the teeth.

For the scenario (3), as shown in FIG. 9, the closer the current motion orientation is to the reference axis 100b, the longer the cleaning time corresponding to the second parameter of the driving shaft is, so as to improve the cleaning efficiency while improving the cleaning effect on the teeth and meeting the cleaning requirements for the teeth.

When the current motion orientation of the driving shaft includes the relative position:

For the scenario (2), as shown in FIG. 4, the closer the current motion orientation is to the reference 100b, the weaker the protection effect corresponding to the third parameter of the driving shaft.

For the scenario (3), as shown in FIG. 9, the closer the current motion orientation is to the reference axis 100b, the stronger the protection effect corresponding to the third parameter of the driving shaft is.

In this way, by providing different protection effects corresponding to the third parameter for different areas of the teeth, not only are the teeth protected in a targeted manner, but also the user experience is improved.

In a case where the current motion orientation of the driving shaft includes the motion area, for the scenario (1), as shown in FIG. 8, when the current motion orientation is located in the area S1 between the reference axis 100b and the first limit position 100c, the cleaning effect corresponding to the first parameter of the driving shaft is less than the cleaning effect corresponding to the first parameter of the driving shaft when the current motion orientation is located in the area S2 between the reference axis 100b and the second limit position 100d. The closer the current motion orientation to the tooth roost with a relatively heavy dirtiness degree, the better the cleaning effect corresponding to the oral care device.

For the scenario (2), as shown in FIG. 4, an upper tooth area of the oral cavity accounts for a larger proportion. In order to ensure the cleaning of the oral cavity, a greater cleaning effect is provided for the upper teeth. When the current motion orientation is located in the area S1 between the reference axis 100b and the first limit position 100c, the cleaning effect corresponding to the first parameter of the driving shaft is greater than the cleaning effect corresponding to the first parameter of the driving shaft when the motion orientation is located in the area S2 between the reference axis 100b and the second limit position 100d. That is, for the upper tooth area of the oral cavity, a greater cleaning effect is provided to ensure the cleaning effect of the oral cavity (teeth).

For the scenario (2), as shown in FIG. 7, the area between the first limit position 100c and the second limit position 100d includes the middle area S3 and the edge areas on two sides of the middle area S3 (i.e., the first edge area S4 and the second edge area S5 in FIG. 7). The cleaning effect corresponding to the first parameter when the current motion orientation is located in the middle area S3 is less than the cleaning effect corresponding to the first parameter when the current motion orientation is located in the first edge area S4 or the second edge area S5. That is, when the current motion orientation is located in the middle area S3 including the tooth tips (upper tooth tips and lower tooth tips) with a relatively light dirtiness degree, the cleaning effect corresponding to the first parameter is less than the cleaning effect corresponding to the first parameter when the current motion orientation is located in the first edge area S4 or the second edge area S5 including the tooth roots (the upper tooth roots and the lower tooth roots) with a relatively heavy dirtiness degree, thereby ensuring the cleaning effect on the teeth.

For the scenario (3), as shown in FIG. 10, the area between the first limit position 100c and the second limit position 100d includes the middle area S3 and the edge areas on two sides of the middle area S3 (i.e., the first edge area S4 and the second edge area S5 in FIG. 10). The cleaning effect corresponding to the first parameter when the current motion orientation is located in the middle area S3 including the centers of the pits and fissures with a heavier dirtiness degree is greater than the cleaning effect corresponding to the first parameter when the current motion orientation is located in one of the edge areas (the first edge area S4 and the second edge area S5), so as to ensure the cleaning effect on the teeth.

In the case where the current motion orientation of the driving shaft includes the motion area, for the scenario (1), as shown in FIG. 8, when the current motion orientation is located in the area S1 between the reference axis 100b and the first limit position 100c (the tooth tip), the cleaning time corresponding to the second parameter of the driving shaft is less than the cleaning time corresponding to the second parameter of the driving shaft when the motion orientation is located in the area S2 between the reference axis 100b and the second limit position 100d (tooth root).

For the scenario (2), as shown in FIG. 4, when the current motion orientation is located in the area S1 between the reference axis 100b and the first limit position 100c (the upper tooth root), the cleaning time corresponding to the second parameter of the driving shaft is greater than the cleaning time corresponding to the second parameter of the driving shaft when the current motion orientation is located in the area S2 between the reference axis 100b and the second limit position 100d (the lower tooth root).

In this way, by setting a longer cleaning time for the motion area close to the tooth root and the motion area located on the upper teeth, the cleaning effect is ensured while improving the cleaning efficiency.

For scenario (2), as shown in FIG. 7, the cleaning time corresponding to the second parameter when the current motion orientation is located in the middle area S3 including the tooth tips (the upper tooth tips and the lower tooth tips) is less than the cleaning time corresponding to the second parameter when the current motion orientation is located in the first edge area S4 including the upper tooth roots or the second edge area S5 including the lower tooth roots, which improves the cleaning efficiency while ensuring the cleaning effect.

For the scenario (3), as shown in FIG. 10, the cleaning time corresponding to the second parameter when the current motion orientation is located in the middle area S3 including the centers of the pits and fissures is greater than the cleaning time corresponding to the second parameter when the current motion orientation is located in the first edge area S4 or the second edge area S5 including the edge of the pits and the fissures, which improves the cleaning efficiency while ensuring the cleaning effect.

When the current motion orientation of the driving shaft includes the motion area:

For the scenario (1), as shown in FIG. 8, when the current motion orientation is between the reference axis 100b and the first limit position 100c, the protection effect corresponding to the third parameter of the driving shaft is less than the protection effect corresponding to the third parameter of the driving shaft when the current motion orientation is between the reference axis 100b and the second limit position 100d. That is, the protection effect of a position of the teeth near the tooth tips is less than the protection effect of a position of the teeth near the tooth roots.

For the scenario (2), generally speaking, the upper tooth area is stronger than the lower tooth area. As shown in FIG. 4, when the current motion orientation is between the reference axis 100b and the first limit position 100c, the protection effect corresponding to the third parameter of the driving shaft is less than the protection effect corresponding to the third parameter of the driving shaft when the current motion orientation is between the reference axis 100b and the second limit position 100d. That is, when the current motion orientation is between the reference axis 100b including the upper teeth and the first limit position 100c, the protection effect corresponding to the third parameter of the driving shaft is less than the protection effect when the current motion orientation is between the reference axis 100b including the lower teeth and the second limit position 100d.

For the scenario (2), as shown in FIG. 7, the protection effect corresponding to the third parameter when the current motion orientation is located in the middle area S3 is greater than the protection effect corresponding to the third parameter when the current motion orientation is located in the edge area. That is, when the current motion orientation is located in the middle area S3 including the tooth tips, the protection effect corresponding to the third parameter is less than the protection effect corresponding to the third parameter when the current motion orientation is located in the first edge area S4 including the upper tooth roots and the second edge area S5 including the lower tooth roots, so as to achieve targeted protection.

For the scenario (3), as shown in FIG. 10, the protection effect corresponding to the third parameter when the current motion orientation is in the middle area S3 is less than the protection effect corresponding to the third parameter when the current motion orientation is in the edge area. That is, when the current motion orientation is in the middle area S3 including the centers of the pits and fissures, the protection effect corresponding to the third parameter is greater than the protection effect corresponding to the third parameter when the current motion orientation is in the first edge area S4 or the second edge area S5 including the edges of the pits and fissures, so as to achieve targeted protection.

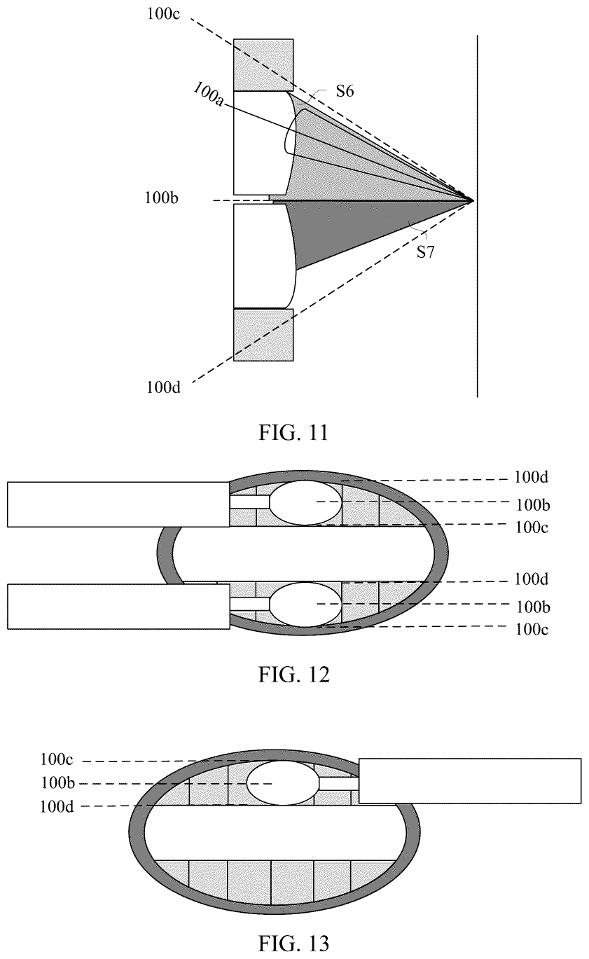

In the case where the current motion orientation of the driving shaft includes the motion area, for the scenario (2), the proportion of an area of the upper teeth is greater than the proportion of an area of the loser teeth. As shown in FIGS. 4 and 11, the cleaning range changes the actual motion range within the first motion range when the oral care device performs the loosening motion. When the current motion orientation is between the reference axis 100b and the first limit position 100c (the upper tooth root), the cleaning range S6 corresponding to the fourth parameter of the driving shaft is greater than the cleaning range S7 corresponding to the fourth parameter of the driving shaft when the current motion orientation is between the reference axis 100b and the second limit position 100d (the lower tooth root), so as to ensure the cleaning efficiency and cleaning effect. In another case, when the current motion orientation is between the reference axis 100b and the first limit position 100c (the upper tooth root), the cleaning range corresponding to the fourth parameter of the driving shaft is less than the cleaning range corresponding to the fourth parameter of the driving shaft when the current motion orientation is between the reference axis 100b and the second limit position 100d (the lower tooth root).

In some embodiments, the cleaning range corresponding to the fourth parameter is understood as the motion range of the driving shaft. For example: based on the reference axis 100b, the motion range of the driving shaft from the reference axis 100b toward the first limit position 100c is different from the motion range of the driving shaft from the reference axis 100b toward the second limit position 100d. For example, the motion range of the driving shaft from the reference axis 100b toward the first limit position 100c is greater than the motion range of the driving shaft from the reference axis 100b toward the second limit position 100d. It is further understood that a distance from the position of the first limit position 100c to the reference axis 100b is not equal to a distance from the position of the second limit position 100d to the reference axis 100bl. In other words, an angle formed between the first limit position 100cd and the reference axis is different from an angle formed between the second limit position 100d and the reference axis 100b. The cleaning range corresponding to the fourth parameter in other embodiments may refer to the embodiment depicted herein, which is not repeatedly described.

In the case where the current motion orientation of the driving shaft includes the absolute direction of the motion direction, for scenario (1), as shown in FIG. 8, when the current motion orientation is the direction D1 from the first limit position 100c to the second limit position 100d, the cleaning effect corresponding to the first parameter of the driving shaft increases. When the current motion orientation is the direction D2 from the second limit position 100d to the first limit position 100c, the cleaning effect corresponding to the first parameter of the driving shaft decreases. That is, when cleaning the tooth roots with a relatively heavy dirtiness degree, the cleaning effect corresponding to the first parameter increases. When cleaning the tooth tips with a relatively light dirtiness degree, the cleaning effect corresponding to the first parameter is reduced, thereby improving the cleaning effect on the teeth and meeting the cleaning needs for the teeth.

For the scenario (2), as shown in FIG. 4, when the current motion direction is the direction D1 from the first limit position 100c to the second limit position 100d or is the direction D2 from the second limit position 100d to the first limit position 100c, the cleaning effect corresponding to the first parameter of the driving shaft first decreases and then increases, so that the closer to the tooth roots, the better the cleaning effect, and the cleaning efficiency is improved while improving the cleaning effect on the teeth and meeting the cleaning needs of the teeth.

For the scenario (3), as shown in FIG. 9, when the motion direction is the direction D1 from the first limit position 100c (the first edge of the pits and fissures) to the second limit position 100d (the second edge of the pits and fissures) or is the direction D2 from the second limit position 100d to the first limit position 100c, the cleaning effect corresponding to the first parameter of the driving shaft first increases and then decreases. The closer to the centers of the pits and fissures where the dirtiness degree is relatively heavy, the better the cleaning effect, and the cleaning efficiency is improved while improving the cleaning effect on the teeth and meeting the cleaning needs of the teeth.

In a case where the current motion orientation of the driving shaft includes the absolute direction of the motion direction, for the scenario (1), as shown in FIG. 8, when the current motion orientation is the direction D1 from the first limit position 100c (the tooth tip) to the second limit position 100d (the tooth root), the cleaning time corresponding to the second parameter of the driving shaft increases. When the current motion orientation is the direction D2 from the second limit position 100d to the first limit position 100c, the cleaning time corresponding to the second parameter of the driving shaft decreases. That is, the closer the current motion orientation of the driving shaft to the second limit position 100d (the tooth root) where the dirtiness degree is relatively heavy, the longer the cleaning time corresponding to the oral care device, so as to ensure the cleaning effect while improving the cleaning efficiency.

For the scenario (2), as shown in FIG. 4, when the current motion orientation is the direction from the first limit position 100c (the upper tooth root) to the second limit position 100d (the lower tooth root) or is the direction from the second limit position 100d to the first limit position 100c, the cleaning time corresponding to the second parameter of the driving shaft first decreases and then increases. That is, the closer the current motion orientation of the driving shaft to the tooth root, the longer the cleaning time, so as to improve the cleaning efficiency while satisfying the cleaning effect on the teeth.

For the scenario (3), as shown in FIG. 9, when the current motion direction is the direction D1 from the first limit position 100c (the first edge of the pits and fissures) to the second limit position 100d (the second edge of the pits and fissures) or the direction D2 from the second limit position 100d to the first limit position 100c, the cleaning time corresponding to the second parameter of the driving shaft first increases and then decreases. That is, the closer the current motion orientation of the driving shaft to the centers of the pits and fissures where the dirtiness degree is relatively heavy and more difficult to clean, the longer the cleaning time, thereby improving the cleaning efficiency while improving the cleaning effect on the teeth and meeting the cleaning needs for the teeth.

In the case where the current motion orientation of the driving shaft includes the absolute direction of the motion direction, for the scenario (1), as shown in FIG. 8, when the current motion orientation is the direction D1 from the first limit position 100c to the second limit position 100d, the protection effect corresponding to the third parameter of the driving shaft increases. When the current motion orientation is the direction D2 from the second limit position 100d to the first limit position 100c, the protection effect corresponding to the third parameter of the driving shaft decreases.

For the scenario (2), as shown in FIG. 4, when the current motion orientation is the direction D1 from the first limit position 100c to the second limit position 100d or is the direction D2 from the second limit position 100d to the first limit position 100c, the protection effect corresponding to the third parameter of the driving shaft first decreases and then increases.

In this way, in the scenarios (1) and (2), the closer the current motion orientation of the driving shaft is to the tooth root where the gum tissue is softer and more sensitive, the better the protection effect of the oral care device, so as to provide targeted protection for different areas of the teeth when cleaning the oral cavity, thereby improving the user experience.

For the scenario (3), as shown in FIG. 9, when the current motion direction of the driving shaft is from the first limit position 100c to the second limit position 100d or is from the second limit position 100d to the first limit position 100c, the protection effect corresponding to the third parameter of the driving shaft first increases and then decreases, so that the closer the current motion direction of the driving shaft to the center of the pits and fissures, the better the protection effect, thereby providing effective protection for the teeth and improving the user experience.

In a case where the current motion orientation of the driving shaft includes the relative direction of the motion direction, for the scenario (1), as shown in FIG. 8, when the current motion orientation is the direction D3 away from the reference axis 100b, the cleaning effect corresponding to the first parameter of the driving shaft increases or decreases. When the current motion orientation is the direction D4 close to the reference axis 100b, the cleaning effect corresponding to the first parameter of the driving shaft decreases or increases. For example, as shown in FIG. 8, the direction D3 away from the reference axis 100b includes a direction D31 and a direction D32. The direction D31 is away from the reference axis 100b and close to the first limit position 100c, and the direction D32 is away from the reference axis 100b and close to the second limit position 100d. The direction D4 close to the reference axis 100b includes a direction D41 and a direction D42. The direction D41 is close to the reference axis 100b and away from the first limit position 100c, and the direction D42 is close to the reference axis 100b and away from the second limit position 100d. In the case where the current motion orientation is the direction D31, the cleaning effect corresponding to the first parameter decreases. In the case where the current motion orientation of the driving shaft is the direction D32, the cleaning effect corresponding to the first parameter decreases. When the current motion direction of the driving shaft is the direction D42, the cleaning effect corresponding to the first parameter decreases. When the current motion direction is the direction D41, the cleaning effect corresponding to the first parameter decreases.

In this way, the cleaning effect adaptively increases or decreases, ensuring the cleaning effect on the teeth while improving the cleaning efficiency.

For the scenario (2), as shown in FIG. 6, when the current motion direction is the direction D3 away from the reference axis 100b, the cleaning effect corresponding to the first parameter of the driving shaft increases. When the current motion direction is the direction D4 close to the reference axis 100b, the cleaning effect corresponding to the first parameter of the driving shaft decreases, which improves the cleaning efficiency while improving the cleaning effect on the teeth and meeting the cleaning needs of the teeth.

For the scenario (3), as shown in FIG. 9, when the current motion direction is the direction D3 away from the reference axis 100b, the cleaning effect corresponding to the first parameter of the driving shaft decreases. When the current motion direction is the direction D4 close to the reference axis 100b, the cleaning effect corresponding to the first parameter of the driving shaft increases to improve the cleaning effect on the teeth and meet the cleaning needs of the teeth.

In the case where the current motion orientation of the driving shaft includes the relative direction of the motion direction, for the scenario (1), as shown in FIG. 8, when the current motion orientation is the direction D3 away from the reference axis 100b, the cleaning time corresponding to the second parameter of the driving shaft increases or decreases. When the current motion orientation is the direction D4 close to the reference axis 100b, the cleaning time corresponding to the second parameter of the driving shaft decreases or increases. For example, as shown in FIG. 8, when the current motion orientation is the direction D31, the cleaning time corresponding to the second parameter decreases. When the current motion orientation is the direction D32, the cleaning time corresponding to the second parameter increases. When the current motion orientation is the direction D41, the cleaning time corresponding to the second parameter increases. When the current motion orientation is the direction D42, the cleaning time corresponding to the second parameter decreases. By adaptively increasing or decreasing the cleaning time, the cleaning efficiency is improved while ensuring the cleaning effect and cleaning kinetic energy.

For the scenario (2), as shown in FIG. 6, when the current motion direction is the direction D3 away from the reference axis 100b, the cleaning time corresponding to the second parameter of the driving axis increases. When the current motion direction is the direction D4 close to the reference axis 100b, the cleaning time corresponding to the second parameter of the driving axis decreases, thereby improving the cleaning efficiency while meeting the demand for the cleaning effect of the teeth.

For the scenario (3), as shown in FIG. 9, when the current motion direction is the direction D3 away from the reference axis 100b, the cleaning time corresponding to the second parameter of the driving axis decreases. When the current motion direction is the direction D4 close to the reference axis 100b, the cleaning time corresponding to the second parameter of the driving axis increases, thereby improving the cleaning effect of the teeth and meeting the demand for the cleaning of the teeth while improving the cleaning efficiency.

In the case where the current motion orientation of the driving shaft includes the relative direction of the motion direction, for the scenario (1), as shown in FIG. 8, when the current motion orientation is the direction D3 away from the reference axis 100b, the protection effect corresponding to the third parameter of the driving shaft increases or decreases. When the current motion orientation is the direction D4 close to the reference axis 100b, the protection effect corresponding to the third parameter of the driving shaft decreases or increases. For example, as shown in FIG. 8, when the current motion orientation is the direction D32, the protection effect corresponding to the third parameter of the driving shaft increases. When the current motion orientation is D31, the protection effect corresponding to the third parameter of the driving shaft decreases. When the current motion orientation is the direction D41, the protection effect corresponding to the third parameter of the driving shaft increases. When the current motion orientation is the direction D42, the protection effect corresponding to the third parameter of the driving shaft decreases.

For the scenario (2), as shown in FIG. 6, when the current motion orientation is the direction D3 away from the reference axis 100b, the protection effect corresponding to the third parameter of the driving shaft increases. When the current motion orientation is the direction D4 close to the reference axis 100b, the protection effect corresponding to the third parameter of the driving shaft decreases.

For the scenario (3), as shown in FIG. 9, when the current motion orientation is the direction D3 away from the reference axis 100b, the protection effect corresponding to the third parameter of the driving shaft decreases. When the current motion orientation is the direction D4 close to the reference axis 100b, the protection effect corresponding to the third parameter of the driving shaft increases.

In this way, the closer the current motion orientation to the tooth root where the gum tissue is softer and more sensitive, and the closer the current motion orientation to the centers of the pits and fissures where it is relatively weak, the better the protection effect of the oral care device. Therefore, different areas of the teeth are protected in a targeted manner when cleaning the oral cavity, and the user experience is improved.

In the case where the current motion orientation of the driving shaft includes the absolute position and the absolute direction of the motion direction, for the scenario (2), as shown in FIG. 6, when the current motion orientation is the direction D1 from the first limit position 100c to the second limit position 100d, and is located between the first limit position 100c and the reference axis 100b, the cleaning effect corresponding to the first parameter of the driving shaft decreases. When the current motion orientation is the direction D1 from the first limit position 100c to the second limit position 100d, and is located between the second limit position 100d and the reference axis 100b (the lower teeth), the cleaning effect corresponding to the first parameter of the driving shaft increases.

For the scenario (2), as shown in FIG. 6, when the current motion orientation is the direction D2 from the second limit position 100d to the first limit position 100c, and is located between the first limit position 100c and the reference axis 100b, the cleaning effect corresponding to the first parameter of the driving shaft increases. When the current motion orientation is the direction D2 from the second limit position 100d to the first limit position 100c, and is located between the second limit position 100d and the reference axis 100b, the cleaning effect corresponding to the first parameter of the driving shaft decreases.

In this way, when the driving shaft moves toward the tooth tips to clean the tooth tips, the cleaning effect corresponding to the first parameter of the driving shaft decreases. When the driving shaft moves toward the tooth roots to clean the tooth roots, the cleaning effect corresponding to the first parameter of the driving shaft increases, thereby improving the cleaning effect on the teeth and meeting the cleaning needs for the teeth.

For the scenario (3), as shown in FIG. 9, when the current motion orientation is the direction D1 from the first limit position 100c to the second limit position 100d, and is located between the first limit position 100c and the reference axis, the cleaning effect corresponding to the first parameter of the driving shaft increases. When the current motion orientation is the direction D1 from the first limit position 100c to the second limit position 100d, and is located between the second limit position 100d and the reference axis, the cleaning effect corresponding to the first parameter of the driving shaft decreases. When the current motion orientation is the direction D2 from the second limit position 100d to the first limit position 100c, and is located between the first limit position 100c and the reference axis, the cleaning effect corresponding to the first parameter of the driving shaft decreases. When the current motion orientation is the direction D2 from the second limit position 100d to the first limit position 100c, and is located between the second limit position 100d and the reference axis, the cleaning effect corresponding to the first parameter of the driving shaft increases. In this way, when the driving shaft approaches the centers of the pits and fissures, the cleaning effect corresponding to the first parameter of the driving shaft increases. When the driving shaft approaches one of the edges of the pits and fissures, the cleaning effect corresponding to the first parameter of the driving shaft decreases, thereby improving the cleaning efficiency while improving the cleaning effect on the teeth and meeting the cleaning needs of the teeth.

In the case where the current motion orientation of the driving shaft includes the absolute position and the absolute direction of the motion direction, for the scenario (2), as shown in FIG. 6, when the current motion orientation is the direction D1 from the first limit position 100c (the upper tooth root) to the second limit position 100d (the lower tooth root), and is located between the first limit position 100c and the reference axis 100b, the cleaning time corresponding to the second parameter of the driving shaft decreases. When the current motion orientation is the direction D1 from the first limit position 100c to the second limit position 100d, and is located between the second limit position 100d and the reference axis 100b, the cleaning time corresponding to the second parameter of the driving shaft increases.

For the scenario (2), as shown in FIG. 6, when the current motion orientation is the direction D2 from the second limit position 100d to the first limit position 100c, and is located between the first limit position 100c and the reference axis 100b, the cleaning time corresponding to the second parameter of the driving shaft increases. When the current motion orientation is the direction D2 from the second limit position 100d to the first limit position 100c, and is located between the second limit position 100d and the reference axis 100b, the cleaning time corresponding to the second parameter of the driving shaft decreases.

In this way, the closer the current motion orientation to the tooth roots, the longer the cleaning time, thereby improving the cleaning efficiency while satisfying the cleaning effect on the teeth.

For the scenario (3), as shown in FIG. 9, when the current motion orientation is the direction D1 from the first limit position 100c to the second limit position 100d, and is located between the first limit position 100c and the reference axis 100b, the cleaning time corresponding to the second parameter of the driving shaft increases. When the current motion orientation is the direction D1 from the first limit position 100c to the second limit position 100d, and is located between the second limit position 100d and the reference axis 100b, the cleaning time corresponding to the second parameter of the driving shaft decreases.

For the scenario (3), as shown in FIG. 9, when the current motion orientation is the direction D2 from the second limit position 100d to the first limit position 100c, and is located between the first limit position 100c and the reference axis 100b, the cleaning time corresponding to the second parameter of the driving shaft decreases. When the current motion orientation is the direction D2 from the second limit position 100d to the first limit position 100c, and is located between the second limit position 100d and the reference axis 100b, the cleaning time corresponding to the second parameter of the driving shaft increases.

In this way, the closer the current motion orientation to the centers of the pits and fissures where the dirtiness degree is relatively heavy and more difficult to clean, the longer the cleaning time is, thereby improving the cleaning efficiency while improving the cleaning effect on the teeth and meeting the cleaning needs of the teeth.

In the case where the current motion orientation of the driving shaft includes the absolute position and the absolute direction of the motion direction, for the scenario (2), as shown in FIG. 6, when the current motion orientation is the direction D1 from the first limit position 100c to the second limit position 100d and is located between the first limit position 100c and the reference axis 100b, the protection effect corresponding to the third parameter of the driving shaft decreases. When the current motion orientation is the direction D1 from the first limit position 100c to the second limit position 100d and is located between the second limit position 100d and the reference axis 100b, the protection effect corresponding to the third parameter of the driving shaft increases.

For the scenario (2), as shown in FIG. 6, when the current motion orientation is the direction D2 from the second limit position 100d to the first limit position 100c and is located between the first limit position 100c and the reference axis 100b, the protection effect corresponding to the third parameter of the driving shaft increases. When the current motion orientation is the direction D2 from the second limit position 100d to the first limit position 100c and is located between the second limit position 100d and the reference axis 100b, the protection effect corresponding to the third parameter of the driving shaft decreases. In this way, the closer the current motion orientation is to the tooth roots where the gum tissue is softer and more sensitive, the better the protection effect of the oral care device, so as to provide targeted protection for different areas of the teeth when cleaning the mouth, thereby improving the user experience.

For the scenario (3), as shown in FIG. 9, when the current motion orientation is the direction D1 from the first limit position 100c to the second limit position 100d and is located between the first limit position 100c and the reference axis 100b, the protection effect corresponding to the third parameter of the driving shaft increases. When the current motion orientation is the direction D1 from the first limit position 100c to the second limit position 100d and is located between the second limit position 100d and the reference axis 100b, the protection effect corresponding to the third parameter of the driving shaft decreases.

For the scenario (3), as shown in FIG. 9, when the current motion orientation is the direction D2 from the second limit position 100d to the first limit position 100c and is located between the first limit position 100c and the reference axis 100b, the protection effect corresponding to the third parameter of the driving shaft decreases. When the current motion orientation is the direction D2 from the second limit position 100d to the first limit position 100c and is located between the second limit position 100d and the reference axis 100b, the protection effect corresponding to the third parameter of the driving shaft increases. In this way, the closer the current motion orientation is to the centers of the pits and fissures, the better the protection effect, thereby providing effective protection for the teeth and improving the user experience.

When the current motion orientation of the driving shaft includes the relative direction of the motion area and the motion direction, as shown in FIG. 8, for the scenario (1), the detail description is as follows.

When the current motion orientation is located in the area S1 between the first limit position 100c and the reference axis 100b, the closer the current motion orientation to the reference axis 100b, the stronger the cleaning effect corresponding to the first parameter of the driving shaft. When the current motion orientation is located in the area S2 between the second limit position 100d and the reference axis 100b, the closer the current motion orientation to the reference axis 100b, the weaker the cleaning effect corresponding to the first parameter of the driving shaft.

When the current motion orientation is located in the area S1 between the first limit position 100c and the reference axis 100b, the closer the current motion orientation to the reference axis 100b, the longer the cleaning time corresponding to the second parameter of the driving shaft. When the current motion orientation is located in the area S2 between the second limit position 100d and the reference axis 100b, the closer the current motion orientation to the reference axis 100b, the shorter the cleaning time corresponding to the second parameter of the driving shaft.

When the current motion orientation is located in the area S1 between the first limit position 100c and the reference axis 100b, the closer the current motion orientation to the reference axis 100b, the stronger the protection effect corresponding to the third parameter of the driving shaft. When the current motion orientation is located in the area S2 between the second limit position 100d and the reference axis 100b, the closer the current motion orientation to the reference axis 100b, the weaker the protection effect corresponding to the third parameter of the driving shaft.

In this way, by setting a stronger cleaning effect, a longer cleaning time and a stronger protection effect when the current motion orientation is close to the tooth roots, the teeth are effectively cleaned, the cleaning efficiency is improved, and effective protection is provided.

In some embodiments, the cleaning parameters are changed based on the motion orientations of the driving shaft and the auxiliary features, and the auxiliary features include oral care parameters and/or oral feature parameters.

Optionally, the oral care parameters include at least one of an oral care mode, a posture of the oral care device, an oral care position, an oral care duration, oral care history parameters, and oral care real-time detection parameters. The oral feature parameters include at least one of teeth, gums, tooth gaps, tongue, missing teeth, decayed teeth, and erupted teeth.

Specifically, the oral care mode includes preset modes when the oral care device cleans the teeth. The oral care position includes different tooth areas, different positions of a same tooth, etc. The oral care duration includes ta total duration of oral care, or a duration of care for a certain tooth area or a single tooth, etc. The oral care history parameters include historical cleaning parameters when the user uses the oral care device. The oral care real-time detection parameters are a result of real-time detection of a tooth condition of the user, which is generated based on the amount of plaque, calculus, whether the tooth roots bleeding or redness occurs, etc.

Optionally, the cleaning parameters are determined based on the motion orientations of the driving shaft and care orientations of the driving shaft.

Optionally, the care orientations include at least one of tooth surfaces and tooth areas. The tooth surfaces include buccal side surfaces (outer tooth surfaces), the lingual side surfaces (inner tooth surfaces) and occlusal surfaces (tooth surfaces with the pits and fissures). The tooth areas include the upper tooth area and the lower tooth area.

Specifically, at least one of the tooth surfaces and the tooth areas is identified by a sensor (such as a multi-axis sensor, a visual sensor, an optical sensor, or an external device, etc.). The care orientations include at least one of tooth surfaces and tooth areas. For example, the care orientations include upper outer tooth surfaces (outer tooth surfaces of the upper tooth area), upper inner tooth surfaces (inner tooth surfaces of the upper tooth area), lower outer tooth surfaces (outer tooth surfaces of the lower tooth area), lower inner tooth surfaces (inner tooth surfaces of the lower tooth area), etc.

Optionally, the cleaning parameters respectively corresponding to the buccal side surfaces, the lingual side surfaces and the occlusal surfaces are different.

The cleaning parameters corresponding to the buccal side surface, the lingual side surfaces and the occlusal surface are different. That is, as long as at least one value of the cleaning parameters is different (such as different cleaning frequencies, etc.), there are different cleaning parameters. Different cleaning parameters are respectively set for the buccal side surfaces, the lingual side surfaces and the occlusal surfaces with different dirtiness degrees of dirt, which further ensure the cleaning effect.

Specifically, based on the auxiliary features of the oral care device, the care orientations of the oral care device during oral care are determined, and the cleaning parameters are determined according to the care orientations and the motion orientations of the driving shaft to provide more detailed and comprehensive care effects (such as cleaning effects and care effects, etc.).

Optionally, the care orientations includes a holding hand and at least one of the tooth surfaces and the tooth areas.

Specifically, the holding hand is identified and determined by the sensor (such as the multi-axis sensor, the visual sensor, the optical sensor, or the external device, etc.).

In the case where the current motion orientation includes the absolute position, for the scenario (1), as shown in FIG. 12, when the holding hand is the right hand, the closer the current motion orientation is to the first limit position 100c (tooth tip), the weaker the cleaning effect corresponding to the first parameter of the driving shaft. The closer the current motion orientation is to the second limit position 100d (the tooth root), the stronger the cleaning effect corresponding to the first parameter of the driving shaft.

As shown in FIG. 13, when the holding hand is changed to the left hand, the relative positions of the first limit position 100c, the second limit position 100d and the teeth change. That is, the first limit position 100c is changed to the direction close to the tooth roots of the teeth, and the second limit position 100d is changed to the direction close to the tooth tips of the teeth. When the holding hand is the left hand, the closer the current motion orientation is to the first limit position 100c (the tooth root), the stronger the cleaning effect corresponding to the first parameter of the driving shaft. The closer the current motion orientation is to the second limit position 100d (tooth tip), the weaker the cleaning effect corresponding to the first parameter of the driving shaft.

As shown in FIG. 12, when the holding hand is the right hand, the closer the current motion orientation is to the first limit position 100c (the tooth tip), the shorter the cleaning time corresponding to the second parameter of the driving shaft. The closer the current motion orientation is to the second limit position 100d (the tooth root), the stronger the cleaning time corresponding to the second parameter of the driving shaft.

As shown in FIG. 13, when the holding hand is changed to the left hand, the relative positions of the first limit position 100c, the second limit position 100d and the teeth change. That is, the first limit position 100c is changed to the direction close to the tooth roots of the teeth, and the second limit position 100d is the direction close to the tooth tips of the teeth. When the holding hand is the left hand, the closer the current motion orientation is to the first limit position 100c, the longer the cleaning effect corresponding to the first parameter of the driving shaft. The closer the current motion orientation is to the second limit position 100d, the shorter the cleaning effect corresponding to the first parameter of the driving shaft.

As shown in FIG. 12, when the holding hand is the right hand, the closer the current motion orientation is to the first limit position 100c, the weaker the protection effect corresponding to the third parameter of the driving shaft. The closer the current motion orientation is to the second limit position 100d, the stronger the protection effect corresponding to the third parameter of the driving shaft.

As shown in FIG. 13, when the holding hand is changed to the left hand, the relative positions of the first limit position 100c, the second limit position 100d and the teeth change. That is, the first limit position 100c is changed to the direction close to the tooth roots of the teeth, and the second limit position 100d is the direction close to the tooth tips of the teeth. When the holding hand is the left hand, the closer the current motion orientation is to the first limit position 100c, the stronger the protection effect corresponding to the third parameter of the driving shaft. The closer the current motion orientation is to the second limit position 100d, the weaker the protection effect corresponding to the third parameter of the driving shaft.

In the case where the current motion orientation includes the motion area, for the scenario (1), as shown in FIG. 12, when the holding hand is the right hand, the current motion orientation of the driving shaft is located between the reference axis and the first limit position 100c, the cleaning effect corresponding to the first parameter is less than the cleaning effect corresponding to the first parameter of the driving shaft when the current motion orientation of the driving shaft is between the reference axis and the second limit position 100d.

For the scenario (1), as shown in FIG. 13, when the holding hand is changed to the left hand, the relative positions of the first limit position 100c, the second limit position 100d and the teeth change. That is, the first limit position 100c is changed to the direction close to the tooth roots of the teeth, and the second limit position 100d is the direction close to the tooth tips of the teeth. In the case where the holding hand is the left hand, and when the current motion orientation of the driving shaft is between the reference axis and the first limit position 100c, the cleaning effect corresponding to the first parameter of the driving shaft is greater than the cleaning effect corresponding to the first parameter when the current motion orientation of the driving shaft is between the reference axis and the second limit position 100d.

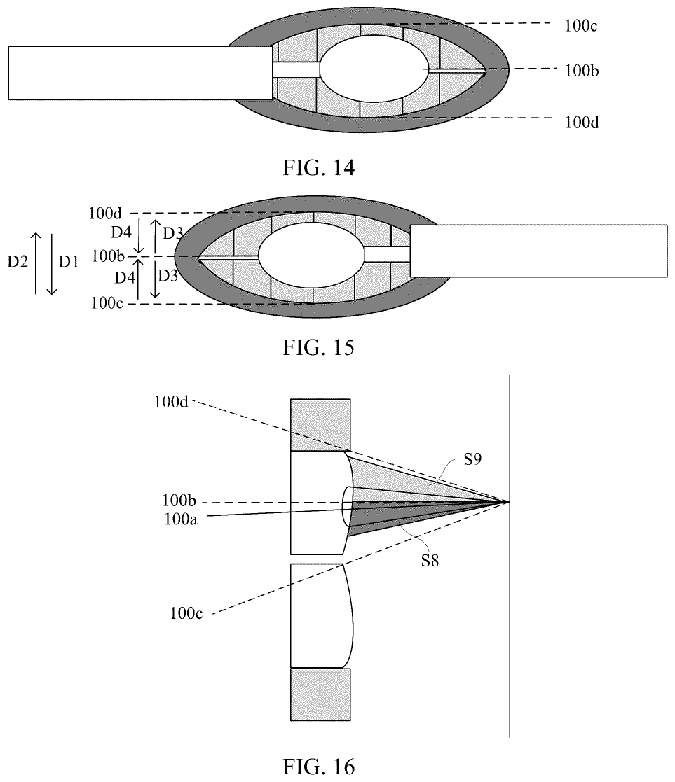

For the scenario (2), as shown in FIGS. 4 and 14, the upper tooth area generally accounts for a larger proportion. When the holding hand is the right hand, the cleaning effect corresponding to the first parameter when the current motion orientation of the driving shaft is between the reference axis 100b and the first limit position 100c (the upper tooth root) is greater than the cleaning effect corresponding to the first parameter when the current motion orientation of the driving shaft is between the reference axis 100b and the second limit position 100d (the lower tooth root),

For the scenario (2), as shown in FIGS. 4 and 15, when the holding hand is changed to the left hand, the relative positions of the first limit position 100c, the second limit position 100d and the teeth change. That is, the first limit position 100c is changed to the direction close to the tooth roots of the teeth, and the second limit position 100d is the direction close to the tooth tips of the teeth. When the holding hand is the left hand, the cleaning effect corresponding to the first parameter when the current motion orientation of the driving shaft is between the reference axis 100b and the first limit position 100c (the lower tooth root) is less than the cleaning effect corresponding to the first parameter when the current motion orientation of the driving shaft is between the reference axis 100b and the second limit position 100d (the upper tooth root).

In the case where the current motion orientation includes the motion area, for the scenario (1), as shown in FIGS. 8 and 12, when the holding hand is the right hand, the cleaning time corresponding to the second parameter of the current motion orientation of the driving shaft between the reference axis 100b and the first limit position 100c is less than the cleaning time corresponding to the second parameter of the driving shaft when the current motion orientation of the driving shaft is between the reference axis 100b and the second limit position 100d.

For the scenario (1), as shown in FIGS. 8 and 13, when the holding hand is changed to the left hand, the relative positions of the first limit position 100c, the second limit position 100d and the teeth change. In the case where the holding hand is the left hand, when the current motion orientation of the driving shaft is between the reference axis 100b and the first limit position 100c, the cleaning time corresponding to the second parameter of the driving shaft is greater than the cleaning time corresponding to the second parameter of the driving shaft when the current motion orientation of the driving shaft is between the reference axis 100b and the second limit position 100d.

For the scenario (2), as shown in FIGS. 4 and 14, when the holding hand is the right hand, when the motion direction of the driving shaft is between the reference axis 100b and the first limit position 100c, the cleaning time corresponding to the second parameter of the driving shaft is greater than the cleaning time corresponding to the second parameter of the driving shaft when the current motion direction of the driving shaft is between the reference axis 100b and the second limit position 100d,

For the scenario (2), as shown in FIGS. 4 and 15, when the holding hand is changed to the left hand, the relative positions of the first limit position 100c, the second limit position 100d and the teeth change. When the holding hand is the left hand, and when the motion direction of the driving shaft is between the reference axis 100b and the first limit position 100c, the cleaning time corresponding to the second parameter of the driving shaft is less than the cleaning time corresponding to the second parameter of the driving shaft when the current motion direction of the driving shaft is between the reference axis 100b and the second limit position 100d.

In the case where the current motion orientation includes the motion area, when the holding hand is changed (such as from the right hand to the left hand), the relative positions of the first limit position, the second limit position and the teeth change.

For the scenario (1), as shown in FIGS. 8 and 12, when the holding hand is the right hand and the current motion orientation of the driving shaft is located between the reference axis 100b and the first limit position 100c, the protection effect corresponding to the third parameter of the driving shaft is less than the protection effect corresponding to the third parameter of the driving shaft when the current motion orientation of the driving shaft is between the reference axis 100b and the second limit position 100d.

For the scenario (1), as shown in FIGS. 8 and 13, when the holding hand is the left hand and the current motion orientation of the driving shaft is located between the reference axis 100b and the first limit position 100c, the protection effect corresponding to the third parameter of the driving shaft is greater than the protection effect corresponding to the third parameter of the driving shaft when the current motion orientation of the driving shaft is between the reference axis 100b and the second limit position 100d.

For the scenario (2), as shown in FIGS. 4 and 14, when the holding hand is the right hand and the current motion orientation of the driving shaft is located between the reference axis 100b and the first limit position 100c, the protection effect corresponding to the third parameter of the driving shaft is less than the protection effect corresponding to the third parameter of the driving shaft when the current motion orientation of the driving shaft is between the reference axis 100b and the second limit position 100d.

For the scenario (2), as shown in FIGS. 4 and 15, when the holding hand is the left hand and the current motion orientation of the driving shaft is located between the reference axis 100b and the first limit position 100c, the protection effect corresponding to the third parameter of the driving shaft is greater than the protection effect corresponding to the third parameter of the driving shaft when the current motion orientation of the driving shaft is located between the reference axis 100b and the second limit position 100d.

When the current motion orientation includes the absolute direction, for the scenario (1), when the holding hand is changed (such as from the right hand to the left hand), the relative positions of the first limit position, the second limit position and the teeth change.

As shown in FIGS. 8 and 12, when the holding hand is the right hand and the current motion orientation is from the first limit position 100c to the second limit position 100d, the cleaning effect corresponding to the first parameter of the driving shaft increases. When the current motion orientation is from the second limit position 100d to the first limit position 10c, the cleaning effect corresponding to the first parameter of the driving shaft decreases.

As shown in FIGS. 8 and 13, when the holding hand is the left hand and the current motion orientation is from the first limit position 100c to the second limit position 100d, the cleaning effect corresponding to the first parameter of the driving shaft decreases. When the current motion orientation is from the second limit position 100d to the first limit position 10c, the cleaning effect corresponding to the first parameter of the driving shaft increases.

As shown in FIGS. 8 and 12, when the holding hand is the right hand and when the current motion orientation is from the first limit position 100c to the second limit position 100d, the cleaning time corresponding to the second parameter of the driving shaft increases. When the current motion orientation is from the second limit position 100d to the first limit position 100c, the cleaning time corresponding to the second parameter of the driving shaft decreases.

As shown in FIGS. 8 and 13, when the holding hand is the left hand and the current motion orientation is from the first limit position 100c to the second limit position 100d, the cleaning time corresponding to the second parameter of the driving shaft decreases. When the current motion orientation moves from the second limit position 100d to the first limit position 100c, the cleaning time corresponding to the second parameter of the driving shaft increases.

As shown in FIGS. 8 and 12, when the holding hand is the right hand and the current motion orientation is from the first limit position 100c to the second limit position 100d, the protection effect corresponding to the third parameter of the driving shaft increases. When the current motion orientation is from the second limit position 100d to the first limit position 100c, the protection effect corresponding to the third parameter of the driving shaft decreases.

As shown in FIGS. 8 and 13, when the holding hand is the left hand and the current motion orientation is from the first limit position 100c to the second limit position 100d, the protection effect corresponding to the third parameter of the driving shaft decreases. When the current motion orientation is from the second limit position 100d to the first limit position 100c, the protection effect corresponding to the third parameter of the driving shaft increases.

The current motion orientation includes the motion area and the relative position. For the scenario (1), when the holding hand is changed (such as from the right hand to the left hand), the relative position of the first limit position, the second limit position, and the teeth change.

As shown in FIGS. 8 and 12, when the holding hand is the right hand and the current motion orientation is located in the area S1 between the first limit position 100c and the reference axis 100b, the closer the current motion orientation is to the reference axis 100b, the stronger the cleaning effect corresponding to the first parameter of the driving shaft. When the holding hand is the right hand and the current motion orientation is located in the area S2 between the second limit position 100d and the reference axis 100b, the closer the current motion orientation is to the reference axis 100b, the weaker the cleaning effect corresponding to the first parameter of the driving shaft.

As shown in FIGS. 8 and 13, when the holding hand is the left hand and the current motion orientation is located in the area S1 between the first limit position 100c and the reference axis 100b, the closer the current motion orientation is to the reference axis 100b, the weaker the cleaning effect corresponding to the first parameter of the driving shaft. When the holding hand is the left hand and the current motion orientation is located in the area S2 between the second limit position 100d and the reference axis 100b, the closer the current motion orientation is to the reference axis 100b, the stronger the cleaning effect corresponding to the first parameter of the driving shaft.

As shown in FIGS. 8 and 12, when the holding hand is the right hand and the current motion orientation is located in the area S1 between the first limit position 100c and the reference axis 100b, the closer the current motion orientation to the reference axis 100b, the longer the cleaning time corresponding to the second parameter of the driving shaft. When the holding hand is the right hand and the current motion orientation is located in the area S2 between the second limit position 100d and the reference axis 100b, the closer the current motion orientation to the reference axis 100b, the shorter the cleaning time corresponding to the second parameter of the driving shaft.

As shown in FIGS. 8 and 13, when the holding hand is the left hand and the current motion orientation is located in the area S1 between the first limit position 100c and the reference axis 100b, the closer the current motion orientation to the reference axis 100b, the shorter the cleaning time corresponding to the second parameter of the driving shaft. When the holding hand is the left hand and the current motion orientation is located in the area S2 between the second limit position 100d and the reference axis 100b, the closer the current motion orientation to the reference axis 100b, the longer the cleaning time corresponding to the second parameter of the driving shaft.

As shown in FIGS. 8 and 12, when the holding hand is the right hand and the current motion orientation is located in the area S1 between the first limit position 100c and the reference axis 100b, the closer the current motion orientation to the reference axis 100b, the stronger the protection effect corresponding to the third parameter of the driving shaft. When the holding hand is the right hand and the current motion orientation is located in the area S2 between the second limit position 100d and the reference axis 100b, the closer the current motion orientation to the reference axis 100b, the weaker the protection effect corresponding to the third parameter of the driving shaft.

As shown in FIGS. 8 and 13, when the holding hand is the left hand and the current motion orientation is located in the area S1 between the first limit position 100c, the tooth root and the reference axis 100b, the closer the current motion orientation is to the reference axis 100b, the weaker the protection effect corresponding to the third parameter of the driving shaft. When the holding hand is the left hand and the current motion orientation is located in the area S2 between the second limit position 100d (the tooth tip) and the reference axis 100b, the closer the current motion orientation to the reference axis 100b, the stronger the protection effect corresponding to the third parameter of the driving shaft.

When the current motion orientation includes the absolute position, for the scenario (1), when the tooth surfaces are changed (such as from the outer tooth surfaces to the inner tooth surfaces), the relative position of the first limit position, the second limit position and the teeth change.

As shown in FIGS. 8 and 12 (assuming that the tooth surfaces shown in FIG. 12 corresponds to the buccal side surfaces (the outer tooth surfaces)) of the teeth, when the current care orientation is on the buccal side surfaces (the outer tooth surfaces), the closer the current motion orientation is to the first limit position 100c, the weaker the cleaning effect corresponding to the first parameter of the driving shaft. When the current care orientation is on the buccal side surfaces the closer the current motion orientation is to the second limit position 100d, the stronger the cleaning effect corresponding to the first parameter of the driving shaft.

When the current care orientation is on the lingual side surfaces of the teeth (the inner tooth surfaces), the closer the current motion orientation is to the first limit position 100c, the stronger the cleaning effect corresponding to the first parameter of the driving shaft. When the current care orientation is on the lingual side surfaces of the teeth, the closer the current motion orientation is to the second limit position 100d, the weaker the cleaning effect corresponding to the first parameter of the driving shaft.

When the current care orientation is located on the buccal side surfaces of the teeth, the closer the current motion orientation is to the first limit position 100c, the shorter the cleaning time corresponding to the second parameter of the driving shaft. When the current care orientation is located on the buccal side surfaces of the teeth, the closer the current motion orientation is to the second limit position 100d, the longer the cleaning time corresponding to the second parameter of the driving shaft.

When the current care orientation is located on the lingual side surfaces of the teeth, the closer the current motion orientation is to the first limit position 100c, the longer the cleaning time corresponding to the second parameter of the driving shaft. When the current care orientation is located on the lingual side surfaces of the teeth, the closer the current motion orientation is to the second limit position 100d, the shorter the cleaning time corresponding to the second parameter of the driving shaft.

When the current care orientation is located on the buccal side surfaces of the teeth, the closer the current motion orientation is to the first limit position 100c, the weaker the protection effect corresponding to the third parameter of the driving shaft. When the current care orientation is located on the buccal side surfaces of the teeth, the closer the current motion orientation is to the second limit position 100d, the stronger the protection effect corresponding to the third parameter of the driving shaft.

When the current care orientation is located on the lingual side surfaces of the teeth, the closer the current motion orientation is to the first limit position 100c, the stronger the protection effect corresponding to the third parameter of the driving shaft. When the current care orientation is located on the lingual side surfaces of the teeth, the closer the current motion orientation is to the second limit position 100d, the weaker the protection effect corresponding to the third parameter of the driving shaft.

In some embodiments, the driving shaft moves between the first limit position and the second limit position on two sides of the reference axis. When the current motion orientation includes the motion area and when the tooth surfaces are changed (such as from the outer tooth surface to the inner tooth surfaces), the relative position of the first limit position, the second limit position and the teeth change.

As shown in FIG. 12, for the scenario (1), when the current care orientation is on the buccal side surfaces of the teeth and the current motion orientation of the driving shaft is located between the reference axis 100b and the first limit position 100c, the cleaning effect corresponding to the first parameter of the driving shaft is less than the cleaning effect corresponding to the first parameter of the driving shaft when the current motion orientation of the driving shaft is between the reference axis 100b and the second limit position 100d.

For the scenario (1), when the current care orientation is on the lingual side surfaces of the teeth and the current motion orientation of the driving shaft is located between the reference axis 100b and the first limit position 100c, the cleaning effect corresponding to the first parameter of the driving shaft is greater than the cleaning effect corresponding to the first parameter of the driving shaft when the current motion orientation of the driving shaft is between the reference axis 100b and the second limit position 100d.

As shown in FIG. 14 (assuming that the tooth surfaces shown in FIG. 14 are the buccal surfaces, i.e., the outer tooth surfaces of the teeth), for the scenario (2), when the current care orientation is located on the buccal side surfaces and the current motion orientation of the driving shaft is located between the reference axis 100b and the first limit position 100c (the upper tooth root), the cleaning effect corresponding to the first parameter of the driving shaft is greater than the cleaning effect corresponding to the first parameter of the driving shaft when the current motion orientation of the driving shaft is located between the reference axis 100b and the second limit position 100d (the lower tooth root).

For the scenario (2), when the current care orientation is located on the lingual side surfaces of the teeth and the current motion orientation of the driving shaft is between the reference axis 100b and the first limit position 100c, the cleaning effect corresponding to the first parameter of the driving shaft is less than the cleaning effect corresponding to the first parameter of the driving shaft when the current motion orientation of the driving shaft is between the reference axis 100b and the second limit position 100d.

In some embodiments, the driving shaft moves between the first limit position and the second limit position on two sides of the reference axis. When the current motion orientation includes the motion area, and when the tooth surfaces are changed (such as from the outer tooth surfaces to the inner tooth surfaces), the relative position of the first limit position, the second limit position and the teeth change.

As shown in FIGS. 8 and 12, for the scenario (1), when the current care orientation is on the buccal side surfaces of the teeth and the current motion orientation of the driving shaft is located between the reference axis 100b and the first limit position 100c, the cleaning time corresponding to the second parameter of the driving shaft is less than the cleaning time corresponding to the second parameter of the driving shaft when the current motion orientation of the driving shaft is between the reference axis 100b and the second limit position 100d.

For the scenario (1), when the current care orientation is on the lingual side surfaces of the teeth and the current motion orientation of the driving shaft is located between the reference axis 100b and the first limit position 100c (the tooth root), the cleaning time corresponding to the second parameter of the driving shaft is greater than the cleaning time corresponding to the second parameter of the driving shaft when the current motion orientation of the driving shaft is between the reference axis 100b and the second limit position 100d.

As shown in FIGS. 4 and 14, for the scenario (2), when the current care orientation is located on the buccal side surfaces and the current motion orientation of the driving shaft is located between the reference axis 100b and the first limit position 100c (the upper tooth root), the cleaning time corresponding to the second parameter of the driving shaft is greater than the cleaning time corresponding to the second parameter of the driving shaft when the current motion orientation of the driving shaft is located between the reference axis 100b and the second limit position 100d.

For the scenario (2), when the current care orientation is located on the lingual side surfaces of the teeth and the current motion orientation of the driving shaft is between the reference axis 100b and the first limit position 100c, the cleaning time corresponding to the second parameter of the driving shaft is less than the cleaning time corresponding to the second parameter of the driving shaft when the current motion orientation of the driving shaft is between the reference axis 100b and the second limit position 100d.

In some embodiments, the driving shaft moves between the first limit position and the second limit position on two sides of the reference axis. When the current motion orientation includes the motion area, and when the tooth surfaces are changed (such as from the outer tooth surfaces to the inner tooth surfaces), the relative position of the first limit position, the second limit position and the teeth change.

As shown in FIGS. 8 and 12, for the scenario (1), when the current care orientation is on the buccal side surfaces of the teeth, and the current motion orientation of the driving shaft is located between the reference axis 100b and the first limit position 100c, the protection effect corresponding to the third parameter of the driving shaft is less than the protection effect corresponding to the third parameter of the driving shaft when the current motion orientation of the driving shaft is between the reference axis 100b and the second limit position 100d.

For the scenario (1), when the current care orientation is on the lingual side surfaces of the teeth and the current motion orientation of the driving shaft is located between the reference axis 100b and the first limit position 100c, the protection effect corresponding to the third parameter of the driving shaft is greater than the protection effect corresponding to the third parameter of the driving shaft when the current motion orientation of the driving shaft is between the reference axis 100b and the second limit position 100d.

As shown in FIGS. 4 and 14, for the scenario (2), when the current care orientation is located on the buccal side surfaces of the teeth and the current motion orientation of the driving shaft is between the reference axis 100b and the first limit position 100c the protection effect corresponding to the third parameter of the driving shaft is less than the protection effect corresponding to the third parameter of the driving shaft when the current motion orientation of the driving shaft is between the reference axis 100b and the second limit position 100d.

For the scenario (2), when the current care orientation is located on the lingual side surfaces of the teeth and the current motion orientation of the driving shaft is between the reference axis 100b and the first limit position 100c, the protection effect corresponding to the third parameter of the driving shaft is greater than the protection effect corresponding to the third parameter of the driving shaft when the current motion orientation of the driving shaft is between the reference axis 100b and the second limit position 100d.

In some embodiments, the driving shaft moves between the first limit position and the second limit position on two sides of the reference axis, the current motion orientation includes the absolute direction. For the scenario (1), when the tooth surfaces are changed (such as from the outer tooth surfaces to the inner tooth surfaces), the relative positions of the first limit position, the second limit position and the teeth change.

As shown in FIGS. 8 and 12, for the scenario (1), when the current care orientation is located on the buccal side surfaces and the current motion orientation moves from the first limit position 100c to the second limit position 100d, the cleaning effect corresponding to the first parameter of the driving shaft increases. When the current motion orientation moves from the second limit position 100d to the first limit position 100c, the cleaning effect corresponding to the first parameter of the driving shaft decreases.

When the current care orientation is located on the lingual side surfaces of the teeth, and the current motion orientation moves from the first limit position 100c to the second limit position 100d, the cleaning effect corresponding to the first parameter of the driving shaft decreases. When the current motion orientation moves from the second limit position 100d to the first limit position 10c, the cleaning effect corresponding to the first parameter of the driving shaft increases.

When the current care orientation is located on the buccal side surfaces of the teeth, and the current motion orientation moves from the first limit position 100c to the second limit position 100d, the cleaning time corresponding to the second parameter of the driving shaft increases. When the current motion orientation moves from the second limit position 100d to the first limit position 100c, the cleaning time corresponding to the second parameter of the driving shaft decreases.

When the current care orientation is located on the lingual side surfaces of the teeth, and the current motion orientation moves from the first limit position 100c to the second limit position 100d, the cleaning time corresponding to the second parameter of the driving shaft decreases. When the current motion orientation moves from the second limit position 100d to the first limit position 100c, the cleaning time corresponding to the second parameter of the driving shaft increases.

When the current care orientation is on the buccal side surfaces of the teeth, and the current motion orientation moves from the first limit position 100c to the second limit position 100d, the protection effect corresponding to the third parameter of the driving shaft increases. When the current motion orientation moves from the second limit position 100d to the first limit position 100c, the protection effect corresponding to the third parameter of the driving shaft decreases.

When the current care orientation is located on the lingual side surfaces of the teeth and the current motion orientation is from the first limit position 100c to the second limit position 100d, the protection effect corresponding to the third parameter of the driving shaft decreases. When the current motion orientation is from the second limit position 100d to the first limit position 100c, the protection effect corresponding to the third parameter of the driving shaft increases.

When the current motion orientation includes the motion area and the relative direction, for the scenario (1), when the tooth surfaces are changed (such as from the outer tooth surfaces to the inner tooth surfaces), the relative positions of the first limit position, the second limit position and the teeth change.

As shown in FIGS. 8 and 12, when the current care orientation is on the buccal side surfaces of the teeth and the current motion orientation is located between the first limit position 100c and the reference axis 100b, the closer the current motion orientation is to the reference axis 100b, the stronger the cleaning effect corresponding to the first parameter of the driving shaft. When the current care orientation is on the buccal side surfaces of the teeth and the current motion orientation is located between the second limit position 100d and the reference axis 100b, the closer the current motion orientation is to the reference axis 100b, the weaker the cleaning effect corresponding to the first parameter of the driving shaft.

When the current care orientation is located on the lingual side surfaces of the teeth and the current motion orientation is located between the first limit position 100c and the reference axis 100b, the closer the current motion orientation is to the reference axis 100b, the weaker the cleaning effect corresponding to the first parameter of the driving shaft. When the current care orientation is located on the lingual side surfaces of the teeth and the current motion orientation is located between the second limit position 100d and the reference axis 100b, the closer the current motion orientation is to the reference axis 100b, the stronger the cleaning effect corresponding to the first parameter of the driving shaft.

When the current care orientation is on the buccal side surfaces of the teeth and the current motion orientation is located between the first limit position 100c and the reference axis 100b, the closer the current motion orientation to the reference axis 100b, the longer the cleaning time corresponding to the second parameter of the driving shaft. When the current care orientation is on the buccal side surfaces of the teeth and the current motion orientation is located in between the second limit position 100d and the reference axis 100b, the closer the current motion orientation to the reference axis 100b, the shorter the cleaning time corresponding to the second parameter of the driving shaft.

When the current care orientation is located on the lingual side surfaces of the teeth and the current motion orientation is located between the first limit position 100c and the reference axis 100b, the closer the current motion orientation to the reference axis 100b, the shorter the cleaning time corresponding to the second parameter of the driving shaft. When the current care orientation is located on the lingual side surfaces of the teeth and the current motion orientation is located between the second limit position 100d and the reference axis 100b, the closer the current motion orientation to the reference axis 100b, the longer the cleaning time corresponding to the second parameter of the driving shaft.

When the current care orientation is on the buccal side surfaces of the teeth and the current motion orientation is located between the first limit position 100c and the reference axis 100b, the closer the current motion orientation to the reference axis 100b, the stronger the protection effect corresponding to the third parameter of the driving shaft. When the current care orientation is on the buccal side surfaces of the teeth and the current motion orientation is located between the second limit position 100d and the reference axis 100b, the closer the current motion orientation to the reference axis 100b, the weaker the protection effect corresponding to the third parameter of the driving shaft.

When the current care orientation is located on the lingual side surfaces of the teeth and the current motion orientation is located between the first limit position 100c and the reference axis 100b, the closer the current motion orientation is to the reference axis 100b, the weaker the protection effect corresponding to the third parameter of the driving shaft. When the current care orientation is located on the lingual side surfaces of the teeth and the current motion orientation is located between the second limit position 100d and the reference axis 100b, the closer the current motion orientation to the reference axis 100b, the stronger the protection effect corresponding to the third parameter of the driving shaft.

In some embodiments, the driving shaft moves between the first limit position and the second limit position on two sides of the reference axis. When the current motion orientation includes the absolute position, for the scenario (1), when the tooth surfaces are changed (such as from the upper outer tooth surfaces to the upper inner tooth surfaces, or from the lower outer tooth surfaces to the lower inner tooth surfaces), the relative position of the first limit position, the second limit position and the teeth change.

As shown in FIG. 12, when the current care orientation is on the buccal side surfaces of the upper tooth area (the upper outer tooth surfaces), the closer the current motion orientation is to the first limit position 100c, the weaker the cleaning effect corresponding to the first parameter of the driving shaft, and the closer the current motion orientation is to the second limit position 100d, the stronger the cleaning effect corresponding to the first parameter of the driving shaft.

When the current care orientation is on the lingual side surfaces of the upper tooth area (the upper inner tooth surfaces), the closer the current motion orientation is to the first limit position 100c, the stronger the cleaning effect corresponding to the first parameter of the driving shaft. When the current care orientation is on the lingual side surfaces of the upper tooth area, the closer the current motion orientation is to the second limit position 100d, the weaker the cleaning effect corresponding to the first parameter of the driving shaft.

As shown in FIG. 12, when the current care orientation is located on the buccal side surfaces of the lower tooth area, the closer the current motion orientation is to the first limit position 100c, the closer the current motion orientation is to the first limit position 100c, the stronger the cleaning effect corresponding to the first parameter of the driving shaft, and the closer the current motion orientation is to the second limit position 100d, the weaker the cleaning effect corresponding to the first parameter of the driving shaft.

When the current care orientation is on the lingual side surfaces of the lower tooth area (the lower inner tooth surfaces), the closer the current motion orientation is to the first limit position 100c, the weaker the cleaning effect corresponding to the first parameter of the driving shaft. When the current care orientation is on the lingual side surfaces of the lower tooth area, the closer the current motion orientation is to the second limit position 100d, the stronger the cleaning effect corresponding to the first parameter of the driving shaft.

In some embodiments, the driving shaft moves between the first limit position and the second limit position on two sides of the reference axis. When the current motion orientation includes the absolute position, for the scenario (1), when the tooth surfaces are changed (such as from the upper outer tooth surfaces to the upper inner tooth surfaces, or from the lower outer tooth surfaces to the lower inner tooth surfaces), the relative position of the first limit position, the second limit position and the teeth change.

As shown in FIGS. 8 and 12, when the current care orientation is on the buccal side surfaces of the upper tooth area, the closer the current motion orientation is to the first limit position 100c, the shorter the cleaning time corresponding to the second parameter of the driving shaft. When the current care orientation is located on the buccal side surfaces of the upper tooth area, the closer the current motion orientation is to the second limit position 100d, the longer the cleaning time corresponding to the second parameter of the driving shaft.

When the current care orientation is located on the lingual side surfaces of the upper tooth area, the closer the current motion orientation is to the first limit position 100c, the longer the cleaning time corresponding to the second parameter of the driving shaft. When the current care orientation is located on the lingual side surfaces of the the upper tooth area, the closer the current motion orientation is to the second limit position 100d, the shorter the cleaning time corresponding to the second parameter of the driving shaft.

When the current care orientation is on the buccal side surfaces of the lower tooth area, the closer the current motion orientation is to the first limit position 100c, the longer the cleaning time corresponding to the second parameter of the driving shaft. When the current care orientation is located on the buccal side surfaces of the lower tooth area, the closer the current motion orientation is to the second limit position 100d, the shorter the cleaning time corresponding to the second parameter of the driving shaft.

When the current care orientation is located on the lingual side surfaces of the lower tooth area, the closer the current motion orientation is to the first limit position 100c, the shorter the cleaning time corresponding to the second parameter of the driving shaft. When the current care orientation is located on the lingual side surfaces of the lower tooth area, the closer the current motion orientation is to the second limit position 100d, the longer the cleaning time corresponding to the second parameter of the driving shaft.

When the current motion orientation includes the absolute position (or the absolute direction), for the scenario (1), when the tooth surfaces are changed (such as from the upper outer tooth surfaces to the upper inner tooth surfaces, or from the lower outer tooth surfaces to the lower inner tooth surfaces), the relative position of the first limit position, the second limit position and the teeth change.

As shown in FIGS. 8 and 12, when the current care orientation is on the buccal side surfaces of the upper tooth area, the closer the current motion orientation is to the first limit position 100c, the weaker the protection effect corresponding to the third parameter of the driving shaft. When the current care orientation is located on the buccal side surfaces of the upper tooth area, the closer the current motion orientation is to the second limit position 100d, the stronger the protection effect corresponding to the third parameter of the driving shaft.

When the current care orientation is located on the lingual side surfaces of the upper tooth area, the closer the current motion orientation is to the first limit position 100c, the stronger the protection effect corresponding to the third parameter of the driving shaft. When the current care orientation is located on the lingual side surfaces of the upper tooth area, the closer the current motion orientation is to the second limit position 100d, the weaker the protection effect corresponding to the third parameter of the driving shaft.

When the current care orientation is on the buccal side surfaces of the lower tooth area, the closer the current motion orientation is to the first limit position 100c, the stronger the protection effect corresponding to the third parameter of the driving shaft. When the current care orientation is located on the buccal side surfaces of the lower tooth area, the closer the current motion orientation is to the second limit position 100d, the weaker the protection effect corresponding to the third parameter of the driving shaft.

When the current care orientation is located on the lingual side surfaces of the lower tooth area, the closer the current motion orientation is to the first limit position 100c, the weaker the protection effect corresponding to the third parameter of the driving shaft. When the current care orientation is located on the lingual side surfaces of the lower tooth area, the closer the current motion orientation is to the second limit position 100d, the stronger the protection effect corresponding to the third parameter of the driving shaft.

In some embodiments, the driving shaft moves between the first limit position and the second limit position on two sides of the reference axis. When the current motion orientation includes the motion area, for the scenario (1), when the tooth surfaces are changed (such as from the upper outer tooth surfaces to the upper inner tooth surfaces, or from the lower outer tooth surfaces to the lower inner tooth surfaces), the relative position of the first limit position, the second limit position and the teeth change.

As shown in FIGS. 8 and 12, when the current care orientation is on the buccal side surfaces of the upper tooth area and the current motion orientation of the driving shaft is located between the reference axis 100b and the first limit position 100c, the cleaning effect corresponding to the first parameter of the driving shaft is less than the cleaning effect corresponding to the first parameter of the driving shaft when the current motion orientation of the driving shaft is between the reference axis 100b and the second limit position 100d.

When the current care orientation is on the lingual side surfaces of the upper tooth area and the current motion orientation of the driving shaft is located between the reference axis 100b and the first limit position 100c, the cleaning effect corresponding to the first parameter of the driving shaft is greater than the cleaning effect corresponding to the first parameter of the driving shaft when the current motion orientation of the driving shaft is between the reference axis 100b and the second limit position 100d.

When the current care orientation is located on the buccal side surfaces of the lower tooth area and the current motion orientation of the driving shaft is located between the reference axis 100b and the first limit position 100c (the upper tooth roots), the cleaning effect corresponding to the first parameter of the driving shaft is greater than the cleaning effect corresponding to the first parameter of the driving shaft when the current motion orientation of the driving shaft is located between the reference axis 100b and the second limit position 100d.

When the current care orientation is located on the lingual side surfaces of the lower tooth area and the current motion orientation of the driving shaft is between the reference axis 100b and the first limit position 100c, the cleaning effect corresponding to the first parameter of the driving shaft is less than the cleaning effect corresponding to the first parameter of the driving shaft when the current motion orientation of the driving shaft is between the reference axis 100b and the second limit position 100d.

When the current motion orientation includes the motion area, for the scenario (1), when the tooth surfaces are changed (such as from the upper outer tooth surfaces to the upper inner tooth surfaces, or from the lower outer tooth surfaces to the lower inner tooth surfaces), the relative position of the first limit position, the second limit position and the teeth change.

As shown in FIGS. 8 and 12, when the current care orientation is on the buccal side surfaces of the upper tooth area and the current motion orientation of the driving shaft is located between the reference axis 100b and the first limit position 100c, the cleaning time corresponding to the second parameter of the driving shaft is less than the cleaning time corresponding to the second parameter of the driving shaft when the current motion orientation of the driving shaft is between the reference axis 100b and the second limit position 100d.

When the current care orientation is on the lingual side surfaces of the upper tooth area and the current motion orientation of the driving shaft is located between the reference axis 100b and the first limit position 100c, the cleaning time corresponding to the second parameter of the driving shaft is greater than the cleaning time corresponding to the second parameter of the driving shaft when the current motion orientation of the driving shaft is between the reference axis 100b and the second limit position 100d.

When the current care orientation is located on the buccal side surfaces of the lower tooth area and the current motion orientation of the driving shaft is located between the reference axis 100b and the first limit position 100c, the cleaning time corresponding to the second parameter of the driving shaft is greater than the cleaning time corresponding to the second parameter of the driving shaft when the current motion orientation of the driving shaft is located between the reference axis 100b and the second limit position 100d.

When the current care orientation is located on the lingual side surfaces of the lower teeth area and the current motion orientation of the driving shaft is between the reference axis 100b and the first limit position 100c, the cleaning time corresponding to the second parameter of the driving shaft is less than the cleaning time corresponding to the second parameter of the driving shaft when the current motion orientation of the driving shaft is between the reference axis 100b and the second limit position 100d.

When the current motion orientation includes the motion area, for the scenario (1), when the tooth surfaces are changed (such as from the upper outer tooth surfaces to the upper inner tooth surfaces, or from the lower outer tooth surfaces to the lower inner tooth surfaces), the relative position of the first limit position, the second limit position and the teeth change.

As shown in FIGS. 8 and 12, for the scenario (1), when the current care orientation is on the buccal side surfaces of the upper tooth area and the current motion orientation of the driving shaft is located between the reference axis 100b and the first limit position 100c, the protection effect corresponding to the third parameter of the driving shaft is less than the protection effect corresponding to the third parameter of the driving shaft when the current motion orientation of the driving shaft is between the reference axis 100b and the second limit position 100d.

When the current care orientation is on the lingual side surfaces of the upper tooth area and the current motion orientation of the driving shaft is located between the reference axis 100b and the first limit position 100c, the protection effect corresponding to the third parameter of the driving shaft is greater than the protection effect corresponding to the third parameter of the driving shaft when the current motion orientation of the driving shaft is between the reference axis 100b and the second limit position 100d.

When the current care orientation is located on the buccal side surfaces of the lower tooth area and the current motion orientation of the driving shaft is between the reference axis 100b and the first limit position 100c the protection effect corresponding to the third parameter of the driving shaft is greater than the protection effect corresponding to the third parameter of the driving shaft when the current motion orientation of the driving shaft is between the reference axis 100b and the second limit position 100d.

When the current care orientation is located on the lingual side surfaces of the lower tooth area and the current motion orientation of the driving shaft is between the reference axis 100b and the first limit position 100c, the protection effect corresponding to the third parameter of the driving shaft is less than the protection effect corresponding to the third parameter of the driving shaft when the current motion orientation of the driving shaft is between the reference axis 100b and the second limit position 100d.

For the scenario (1), when the tooth surfaces are changed (such as from the upper outer tooth surfaces to the upper inner tooth surfaces, or from the lower outer tooth surfaces to the lower inner tooth surfaces), the relative position of the first limit position, the second limit position and the teeth change.

As shown in FIG. 16, when the current care orientation is on the buccal side surfaces of the upper tooth area and the current motion orientation of the driving shaft is located between the reference axis 100b and the first limit position 100c (the tooth tip), the cleaning range S8 corresponding to the fourth parameter of the driving shaft is less than the cleaning range corresponding to the fourth parameter S9 of the driving shaft when the current motion orientation of the driving shaft is between the reference axis 100b and the second limit position 100d.

When the current care orientation is on the lingual side surfaces of the upper tooth area and the current motion orientation of the driving shaft is located between the reference axis 100b and the first limit position 100c, the cleaning range S8 corresponding to the fourth parameter of the driving shaft is greater than the cleaning range S9 corresponding to the fourth parameter of the driving shaft when the current motion orientation of the driving shaft is between the reference axis 100b and the second limit position 100d.

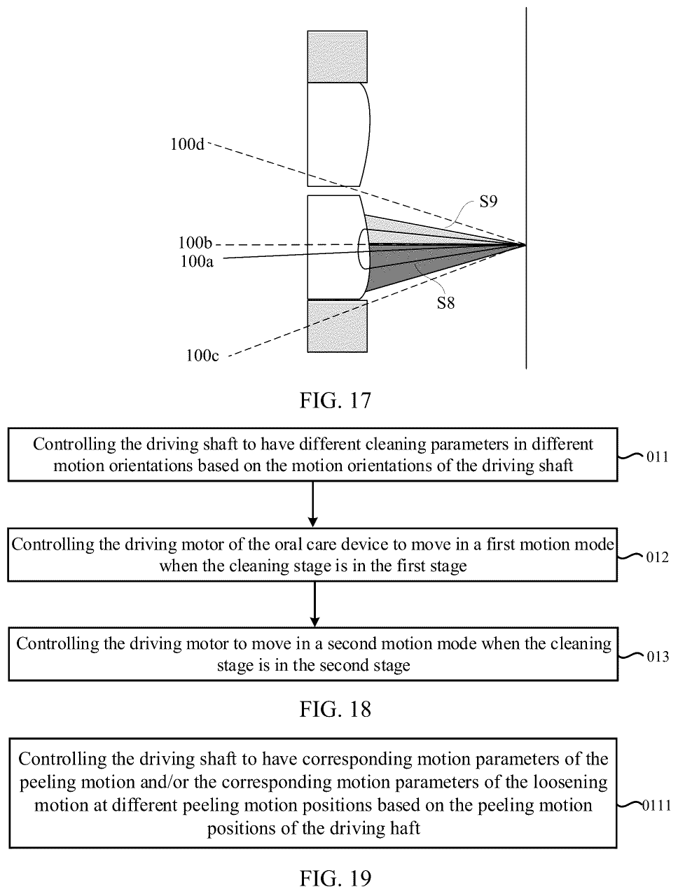

As shown in FIG. 17, when the current care orientation is located on the buccal side surfaces of the lower tooth area and the current motion orientation of the driving shaft is between the reference axis 100b and the first limit position 100c the cleaning range corresponding to the fourth parameter S8 of the driving shaft is greater than the cleaning range S9 corresponding to the fourth parameter of the driving shaft when the current motion orientation of the driving shaft is between the reference axis 100b and the second limit position 100d.

When the current care orientation is located on the lingual side surfaces of the lower tooth area and the current motion orientation of the driving shaft is between the reference axis 100b and the first limit position 100c, the cleaning range S8 corresponding to the fourth parameter of the driving shaft is less than the cleaning range S9 corresponding to the fourth parameter of the driving shaft when the current motion orientation of the driving shaft is between the reference axis 100b and the second limit position 100d.

In some embodiments, the cleaning parameters are determined based on the motion orientations of the driving shaft and a cleaning stage, and the cleaning stage is determined based on the auxiliary feature.

The auxiliary features include an operating time of the oral care device.

The cleaning stage is divided according to the operating time of the oral care device. For example, the cleaning stage is divided into a first cleaning stage and a second cleaning stage.

As shown in FIG. 18, in some embodiments, the cleaning parameters further include a motion mode. The cleaning stage includes the first stage and the second stage. The operation control method further includes steps 012 and 013.

The step 012 includes controlling the driving motor of the oral care device to move in a first motion mode when the cleaning stage is in the first stage.

The step 013 includes controlling the driving motor to move in a second motion mode when the cleaning stage is in the second stage.

The second motion mode is different from the first motion mode.

The first motion mode includes the loosening motion and the peeling motion. The second motion mode includes the loosening motion or the peeling motion.

A duration of the first stage is greater than a duration of the second stage.

Specifically, the cleaning stage is determined by presetting the care duration of the oral care device, and then the cleaning parameters are determined according to the cleaning stage and the motion orientations of the driving shaft. In the first stage, the driving motor of the electric toothbrush is controlled to perform the loosening motion and the peeling motion to ensure the cleaning effect. When the electric toothbrush is in the second stage, the driving motor is controlled to perform the loosening motion or the peeling motion to perform targeted cleaning or sweep away plaque to ensure the cleaning effect and cleaning efficiency.

As shown in FIG. 19, the motion mode of the driving shaft includes the loosening motion and the peeling motion, and the peeling motion is configured to increase or change a motion range of the loosening motion.

The step 011 of controlling the driving shaft to have different cleaning parameters in different motion orientations based on the motion orientations of the driving shaft includes step 0111.

The step 0111 includes controlling the driving shaft to have corresponding motion parameters of the peeling motion and/or the corresponding motion parameters of the loosening motion at different peeling motion positions based on the peeling motion positions of the driving haft,

Specifically, the driving shaft performs the peeling motion on the tooth surfaces of the teeth. The peeling motion changes the relative position of the driving shaft and the teeth, thereby driving the driving shaft to perform the loosening motion at different positions of the teeth and achieving the effect of increasing or changing the motion range of the loosening motion. When the driving shaft is located at different peeling motion positions, it is considered that the oral care device is cleaning different positions of the teeth. By controlling the driving shaft to have different peeling motion parameters and/or different loosening motion parameters at different peeling motion positions, more cleaning methods are provided for different positions or areas of the oral cavity, more cleaning needs are met, and the cleaning effect is guaranteed.

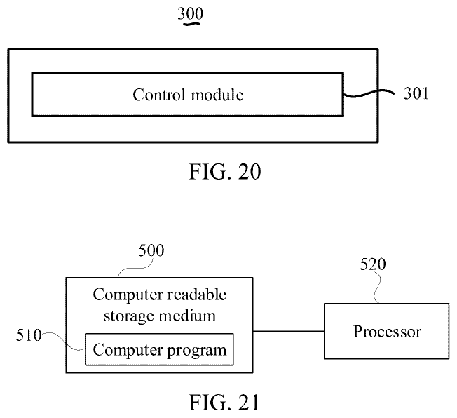

As shown in FIG. 20, in order to implement the operation control method of the oral care device of the embodiments of the present disclosure, the embodiments of the present disclosure further provide an oral care device 300. The oral care device 300 includes a control module 301. The control module 301 is configured to control the driving shaft to have different cleaning parameters in different motion orientations based on the motion orientations of the driving shaft.

It should be noted that the specific details of each module unit in the above-mentioned oral care device 300 have been described in detail in the embodiments of the above-mentioned operation control method, which are not repeatedly described herein.

The oral care device 300 is described above from the perspective of functional modules in conjunction with the accompanying drawings. The functional modules are implemented in hardware modules, or are implemented by instructions in software modules, or are implemented by a combination of the hardware modules and the software modules. Specifically, the steps of the operation control method of the embodiments of the present disclosure may be completed by hardware integrated logic circuits in the processor and/or instructions in software form. The steps of the operation control method disclosed in conjunction with the embodiments of the present disclosure may be directly embodied as being executed by a hardware coding processor, or may be executed by a combination of hardware modules and the software modules in a coding processor. Optionally, the software modules may be disposed in a mature storage medium in the prior art, such as a random access memory, a flash memory, a read-only memory, a programmable read-only memory, an electrically erasable programmable memory, a register, etc. The storage medium is disposed in the memory, and the processor reads the information in the memory and implements the steps in the operation control method of the above embodiments in conjunction with the hardware modules.

As shown in FIGS. 1, 2 and 4, the oral care device 100 includes the driving component 12, a processor 40 and a memory 50. The memory 50 stores a computer program 51 that is run on the processor 40. When the computer program 51 is executed by the processor 40, each process of the embodiment of the operation control method of the oral care device is implemented, and the same technical effect is achieved. For the sake of brevity, the description is not be repeated herein.

In one embodiment, the driving component 12 includes the driving motor, and the driving motor of the driving component 12 includes the servo motor.

In one embodiment, the oral care device 100 includes the electric toothbrush 100.

As shown in FIG. 21, the embodiment of the present disclosure further provides a computer readable storage medium 500, on which a computer program 510 is stored. When the computer program 510 is executed by the processor 520, the steps of the operation control method of the oral care device in any of the above-mentioned embodiments are implemented, which are not repeated herein.

In the description of the present disclosure, the description of reference terms “some embodiments”, “examples”, “some examples”, etc. mean that particular features, structures, materials, or characteristics described in connection with the embodiments or examples are included in at least one embodiment or example of the present disclosure. In the specification, schematic representations of terms do not necessarily refer to the same implementation or example. Any process or method description in a flowchart or otherwise described herein may be understood to represent a module, fragment or portion of code including one or more executable instructions for implementing the steps of a specific logical function or process. The scope of the optional embodiments of the present disclosure includes additional implementations, in which functions may not be performed in the order shown or discussed, including in a substantially simultaneous manner or in reverse order according to the functions involved, which should be understood by those skilled in the art to which the embodiments of the present disclosure belong.

What is claimed is:

1. An operation control method of an oral care device, wherein the oral care device comprises a processor, a driving component, and a care element, the driving component comprises a driving shaft, the driving shaft is connected to the care element, and the driving shaft is configured to drive the care element to rotate and/or stretch out and retract;
wherein the driving shaft rotates circumferentially around a rotor shaft of the driving shaft with a reference position as a center, and the driving shaft rotates in a circumferential direction to switch the reference position, a rotation motion of the care element driven by the driving shaft comprises a peeling motion and a loosening motion, the peeling motion is configured to adjust the reference position of the rotor shaft, and the loosening motion is a reciprocating motion configured to clean teeth;
wherein a motion range of the driving shaft during the loosening motion is defined as a first motion range, and the loosening motion comprises a first reciprocating motion of the driving shaft within the first motion range;
wherein when the driving shaft performs the peeling motion, the reference position performs a second reciprocating motion within a second motion range;
wherein the processor is electrically connected to the driving component;
wherein the operation control method comprises step:
controlling the driving shaft to have different cleaning parameters in different motion orientations based on the motion orientations of the driving shaft;
wherein each of the motion orientations of the driving shaft comprises at least one of an absolute position, a relative position, a motion area, and a motion direction;
wherein each of the cleaning parameters comprises at least one of a first parameter representing a cleaning effect, a second parameter representing a cleaning time, a third parameter representing a protection effect, and a fourth parameter representing a cleaning range.

2. An operation control method of an oral care device, wherein the oral care device comprises a driving component, and the driving component comprises a driving shaft, wherein the operation control method comprises step:
controlling the driving shaft to have different cleaning parameters in different motion orientations based on the motion orientations of the driving shaft;
wherein each of the motion orientations of the driving shaft comprises at least one of an absolute position, a relative position, a motion area, and a motion direction;
wherein each of the cleaning parameters comprises at least one of a first parameter representing a cleaning effect, a second parameter representing a cleaning time, a third parameter representing a protection effect, and a fourth parameter representing a cleaning range.

3. The operation control method according to claim 2, wherein the driving component comprises a position detector, the position detector is configured to detect at least one of a current motion position and a current motion direction of the driving shaft, and a current motion orientation of the driving shaft is determined based on at least one of the current motion position and the current direction of the driving shaft; and/or
in different motion periods, the cleaning parameters corresponding to motion positions of the driving shafts are the same or different.

4. The operation control method according to claim 2, wherein the driving shaft moves between a first limit position and a second limit position, and the first limit position and the second limit position are located on two sides of a reference axis;
wherein the absolute position comprises a position between the first limit position and the second limit position;
wherein the relative position is a position relative to the reference axis, the first limit position, or the second limit position;
wherein the motion area comprises an area between the first limit position and the second limit position;
wherein the motion direction comprises at least one of a direction from the first limit position to the second limit position, a direction from the second limit position to the first limit position, a direction away from the reference axis, and a direction close to the reference axis;
wherein the first parameter comprises at least one of a cleaning frequency, a cleaning intensity, a cleaning amplitude, and a motion speed;
wherein the second parameter comprises at least one of the motion speed, a position switching speed, and a position switching amplitude;
wherein the third parameter comprises at least one of the motion speed, the position switching speed, the position switching amplitude, the cleaning frequency, the cleaning intensity, and the cleaning amplitude;
wherein the fourth parameter comprises the cleaning range.

5. The operation control method according to claim 2, wherein the driving shaft moves between a first limit position and a second limit position, and the first limit position and the second limit position are located on two sides of a reference axis;
wherein when a current motion orientation of the driving shaft moves toward the first limit position, the cleaning effect corresponding to the first parameter of the driving shaft decreases, and when the current motion orientation of the driving shaft moves toward the second limit position, the cleaning effect corresponding to the first parameter of the driving shaft increases; or when the current motion orientation of the driving shaft moves from the first limit position to the second limit position or moves from the second limit position to the first limit position, the cleaning effect corresponding to the first parameter of the driving shaft first decreases and then increases; or when the current motion orientation of the driving shaft moves from the first limit position to the second limit position or moves from the second limit position to the first limit position, the cleaning effect corresponding to the first parameter of the driving shaft first increases and then decreases;
wherein when the current motion orientation of the driving shaft moves toward the first limit position, the cleaning time corresponding to the second parameter of the driving shaft decreases, and when the current motion orientation of the driving shaft moves toward the second limit position, the cleaning time corresponding to the second parameter of the driving shaft increases; or when the current motion orientation of the driving shaft moves from the first limit position to the second limit position or moves from the second limit position to the first limit position, the cleaning time corresponding to the second parameter of the driving shaft first decreases and then increases; or when the current motion orientation of the driving shaft moves from the first limit position to the second limit position or moves from the second limit position to the first limit position, the cleaning time corresponding to the second parameter of the driving shaft first increases and then decreases;
wherein when the current motion orientation of the driving shaft moves toward the first limit position, the protection effect corresponding to the third parameter of the driving shaft decreases, and when the current motion orientation of the driving shaft moves toward the second limit position, the protection effect corresponding to the third parameter of the driving shaft increases; or when the current motion orientation of the driving shaft moves from the first limit position to the second limit position or moves from the second limit position to the first limit position, the protection effect corresponding to the third parameter of the driving shaft first decreases and then increases or when the current motion orientation of the driving shaft moves from the first limit position to the second limit position or moves from the second limit position to the first limit position, the protection effect corresponding to the third parameter of the driving shaft first increases and then decreases.

6. The operation control method according to claim 2, wherein the driving shaft moves between a first limit position and a second limit position, and the first limit position and the second limit position are located on two sides of a reference axis;
wherein when the current motion orientation of the driving shaft is located between the reference axis and the first limit position, the driving shaft has a first cleaning effect corresponding to the first parameter; when the current motion orientation of the driving shaft is located between the reference axis and the second limit position, the driving shaft has a second cleaning effect corresponding to the first parameter; and the first cleaning effect is less than the second cleaning effect, or
when the current motion orientation is located between the reference axis and the first limit position, the driving shaft has the first cleaning effect corresponding to the first parameter; when the current motion orientation is located between the reference axis and the second limit position, the driving shaft has the second cleaning effect corresponding to the first parameter;
and the first cleaning effect is greater than the second cleaning effect, or an area between the first limit position and the second limit position comprises a middle area and edge areas located on two sides of the middle area, when the current motion orientation is located in the middle area, the current motion orientation has a third cleaning effect corresponding to the first parameter; when the current motion orientation is located in any one of the edge areas, the current motion orientation has a fourth cleaning effect corresponding to the first parameter; and the third cleaning effect is greater than or less than the fourth cleaning effect,
wherein when the current motion orientation is located between the reference axis and the first limit position, the driving shaft has a first cleaning time corresponding to the second parameter; when the current motion orientation is located between the reference axis and the second limit position, the driving shaft has a second cleaning time corresponding to the second parameter; and the first cleaning time is less than the second cleaning time, or
when the current motion orientation is located between the reference axis and the first limit position, the driving shaft has the first cleaning time corresponding to the second parameter; when the current motion orientation is located between the reference axis and the second limit position, the driving shaft has the second cleaning time corresponding to the second parameter; and the first cleaning time is greater than the second cleaning time; or
the area between the first limit position and the second limit position comprises the middle area and the edge areas located on the two sides of the middle area; when the current motion orientation is located in the middle area, the driving shaft has a third cleaning time corresponding to the second parameter; when the current motion orientation is located in any one of the edge areas, the driving shaft has a fourth cleaning time corresponding to the second parameter; and the third cleaning time is less than or greater than the fourth cleaning time;
wherein when the current motion orientation is located between the reference axis and the first limit position, the driving shaft has a first protection effect corresponding to the third parameter; when the current motion orientation is located between the reference axis and the second limit position, the driving shaft has a second protection effect corresponding to the third parameter; and the first protection effect is less than the second protection effect; or
when the current motion orientation is located between the reference axis and the first limit position, the driving shaft has the first protection effect corresponding to the third parameter; when the current motion orientation is located between the reference axis and the second limit position, the driving shaft has the second protection effect corresponding to the third parameter; and the first protection effect is greater than the second protection effect; or
the area between the first limit position and the second limit position comprises the middle area and the edge areas located on the two sides of the middle area; when the current motion orientation is located in the middle area, the driving shaft has a third protection effect corresponding to the third parameter; when the current motion orientation is located in any one of the edge areas, the driving shaft has a fourth protection effect corresponding to the third parameter; and the third protection effect is less than or greater than the fourth protection effect.

7. The operation control method according to claim 2, wherein the driving shaft moves between a first limit position and a second limit position, and the first limit position and the second limit position are located on two sides of a reference axis;
wherein when the current motion orientation is located between the reference axis and the first limit position, the driving shaft has a first cleaning range corresponding to the fourth parameter; when the current motion orientation is located between the reference axis and the second limit position, the driving shaft has a second cleaning range corresponding to the fourth parameter; and the first cleaning range is greater than the second cleaning range, or
when the current motion orientation is located between the reference axis and the first limit position, the driving shaft has the first cleaning range corresponding to the fourth parameter; when the current motion orientation is located between the reference axis and the second limit position, the driving shaft has the second cleaning range corresponding to the fourth parameter; and the first cleaning range is less than the second cleaning range.

8. The operation control method according to claim 2, wherein the driving shaft moves between a first limit position and a second limit position, and the first limit position and the second limit position are located on two sides of a reference axis;
wherein when the current motion orientation is from the first limit position to the second limit position, the cleaning effect corresponding to the first parameter of the driving shaft increases and/or the cleaning time corresponding to the second parameter of the driving shaft increases, and/or the protection effect corresponding to the third parameter of the driving shaft increases; or
when the current motion orientation is from the second limit position to the first limit position, the cleaning effect corresponding to the first parameter of the driving shaft decreases, and/or the cleaning time corresponding to the second parameter of the driving shaft decreases, and/or the protection effect corresponding to the third parameter of the driving shaft decreases.

9. The operation control method according to claim 2, wherein when the current motion orientation is from the first limit position to the second limit position, or when the current motion orientation is from the second limit position to the first limit position, the cleaning effect corresponding to the first parameter of the driving shaft first decreases and then increases or first increases and then decreases, and/or the cleaning time corresponding to the second parameter of the driving shaft decreases first and then increases or increases first and then decreases, and/or the protection effect corresponding to the third parameter of the driving shaft first decreases and then increases or first increases and then decreases.

10. The operation control method according to claim 2, wherein the driving shaft moves between a first limit position and a second limit position, and the first limit position and the second limit position are located on two sides of a reference axis;
wherein when the current motion orientation of the driving shaft moves in a direction away from the reference axis, the cleaning effect corresponding to the first parameter of the driving shaft increases or decreases, the cleaning time corresponding to the second parameter of the driving shaft increases or decreases, and the protection effect corresponding to the third parameter of the driving shaft increases;
wherein when the current motion orientation of the driving shaft moves in a direction close to the reference axis, the cleaning effect corresponding to the first parameter of the driving shaft decreases or increases, the cleaning time corresponding to the second parameter of the driving shaft decreases or increases, and the protection effect corresponding to the third parameter of the driving shaft decreases.

11. The operation control method according to claim 2, wherein the driving shaft moves between a first limit position and a second limit position, and the first limit position and the second limit position are located on two sides of a reference axis;
wherein when the current motion orientation of the driving shaft moves from the first limit position to the second limit position and is located between the first limit position and the reference axis, the cleaning effect corresponding to the first parameter of the driving shaft decreases, the cleaning time corresponding to the second parameter of the driving shaft decreases, and the protection effect corresponding to the third parameter of the driving shaft decreases; when the current motion orientation of the driving shaft moves from the second limit position to the first limit position and is located between the first limit position and the reference axis, the cleaning effect corresponding to the first parameter of the driving shaft increases, the cleaning time corresponding to the second parameter of the driving shaft increases, and the protection effect corresponding to the third parameter of the driving shaft increases; when the current motion orientation of the driving shaft moves from the first limit position to the second limit position and is located between the second limit position and the reference axis, the cleaning effect corresponding to the first parameter of the driving shaft increases, the cleaning time corresponding to the second parameter of the driving shaft increases, and the protection effect corresponding to the third parameter of the driving shaft increases,
when the current motion orientation of the driving shaft moves from the second limit position to the first limit position and is located between the first limit position and the reference axis, the cleaning effect corresponding to the first parameter of the driving shaft increases, the cleaning time corresponding to the second parameter of the driving shaft increases, and the protection effect corresponding to the third parameter of the driving shaft increases; when the current motion orientation of the driving shaft moves from the second limit position to the first limit position and is located between the second limit position and the reference axis, the cleaning effect corresponding to the first parameter of the driving shaft decreases, the cleaning time corresponding to the second parameter of the driving shaft decreases, and the protection effect corresponding to the third parameter of the driving shaft decreases; or
wherein when the current motion orientation of the driving shaft moves from the first limit position to the second limit position and is located between the first limit position and the reference axis, the cleaning effect corresponding to the first parameter of the driving shaft increases, the cleaning time corresponding to the second parameter of the driving shaft increases, and the protection effect corresponding to the third parameter of the driving shaft increases; when the current motion orientation of the driving shaft moves from the first limit position to the second limit position and is located between the first limit position and the reference axis, the cleaning effect corresponding to the second parameter of the driving shaft decreases, the cleaning time corresponding to the second parameter of the driving shaft decreases, and the protection effect corresponding to the third parameter of the driving shaft decreases;
when the current motion orientation of the driving shaft is from the second limit position to the first limit position and is located between the first limit position and the reference axis, the cleaning effect corresponding to the first parameter of the driving shaft decreases, the cleaning time corresponding to the second parameter of the driving shaft decreases, and the protection effect corresponding to the third parameter of the driving shaft decreases; when the current motion orientation of the driving shaft moves from the second limit position to the first limit position and is located between the second limit position and the reference axis, the cleaning effect corresponding to the first parameter of the driving shaft increases, the cleaning time corresponding to the second parameter of the driving shaft increases, and the protection effect corresponding to the third parameter of the driving shaft increases.

12. The operation control method according to claim 2, wherein the driving shaft moves between a first limit position and a second limit position, and the first limit position and the second limit position are located on two sides of a reference axis;
when the current motion orientation of the driving draft is located between the first limit position toward the reference axis and moves towards the reference axis, the cleaning effect corresponding to the first parameter of the driving shaft increases, the cleaning time corresponding to the second parameter of the driving shaft increases, and the protection effect corresponding to the third parameter of the driving shaft increases;
when the current motion orientation of the driving draft is located between the second limit position and the reference axis and moves toward the reference axis, the cleaning effect corresponding to the first parameter of the driving shaft decreases, the cleaning time corresponding to the second parameter of the driving shaft decreases, and the protection effect corresponding to the second parameter of the driving shaft decreases.

13. The operation control method according to claim 2, wherein the cleaning parameters vary based on the motion orientations of the driving shaft and auxiliary features, wherein the auxiliary features comprise oral care parameters and/or oral feature parameters;
wherein the oral care parameters comprise at least one of an oral care mode, a posture of the oral care device, an oral care position, an oral care duration, oral care history parameters, and oral care real-time detection parameters; and/or
the oral feature parameters comprise at least one of teeth, gums, tooth gaps, tongue, missing teeth, decayed teeth, and erupted teeth.

14. The operation control method according to claim 13, wherein the cleaning parameters are determined based on the motion orientations of the driving shaft and care orientations of the driving shaft;
wherein the care orientations comprise at least one of tooth surfaces and tooth areas, or the care orientations comprise a holding hand and at least one of the tooth surfaces and the tooth areas.

15. The operation control method according to claim 2, wherein the cleaning parameters are determined based on the motion orientations of the driving shaft and a cleaning stage;
wherein the cleaning parameters further comprise a motion mode, the cleaning stage comprises a first stage and a second stage, and the operation control method further comprises steps:
controlling a driving motor of the oral care device to move in a first motion mode when the cleaning stage is in the first stage; and
controlling the driving motor to move in a second motion mode when the cleaning stage is in the second stage;
wherein the second motion mode is different from the first motion mode.

16. The operation control method according to claim 15, wherein the first motion mode comprises a loosening motion and a peeling motion, the second motion mode comprises one of the loosening motion and the peeling motion; and/or
a duration of the first stage is greater than a duration of the second stage.

17. The operation control method according to claim 2, wherein the motion mode of the driving shaft comprises a loosening motion and a peeling motion, and the peeling motion is configured to increase or change a motion range of the loosening motion;
wherein the step of controlling the driving shaft to have different cleaning parameters in different motion orientations based on the motion orientations of the driving shaft comprises step:
controlling the driving shaft to have corresponding motion parameters of the peeling motion and/or corresponding motion parameters of the loosening motion at different peeling motion positions based on the peeling motion positions of the driving shaft.

18. The operation control method according to claim 17, wherein the loosening motion comprises a first reciprocating motion within a first motion range, and the peeling motion comprises a second reciprocating motion within a second motion range, the first motion range is less than the second motion range, and a frequency of the first reciprocating motion is greater than a frequency of the second reciprocating motion; and/or
the loosening motion and the peeling motion comprise at least one of rotation and translation, and a rotation axis of the driving shaft and a translation direction of the driving shaft are parallel to a long axis of the oral care device; and/or
the driving component comprises a driving motor, and the loosening motion and the peeling motion are performed by the driving motor.

19. An oral care device, comprising:
a driving component;
a processor; and
a memory;
wherein the memory stores a computer program, and the processor implements the operation control method according to claim 2 when executing the computer program.

20. A non-transitory computer readable storage medium, comprising:
a computer program stored thereon;
wherein the computer program is executed by a processor to implement the operation control method according to claim 2.
